(19) United States
(12) Patent Application Publication
(10) Pub. No.: US 2026/0160984 A1
(43) Pub. Date: Jun. 11, 2026

(54) ZOOM LENS AND IMAGING APPARATUS

(71) Applicant: FUJIFILM Corporation, Tokyo (JP)

(72) Inventor: Masaru YONEZAWA, Saitama (JP)

(73) Assignee: FUJIFILM Corporation, Tokyo (JP)

(21) Appl. No.: 19/412,127

(22) Filed: Dec. 8, 2025

(30) Foreign Application Priority Data
Dec. 11, 2024 (JP) 2024-217106

(51) Int. Cl. G02B 15/14

(52) U.S. Cl. CPC G02B 15/1461

(57) ABSTRACT

A zoom lens consisting of a first lens group having a positive refractive power, a second lens group having a positive refractive power, a third lens group having a negative refractive power, a fourth lens group, and a subsequent group consisting of two or more lens groups in order from an object side to an image side, wherein: all of spacings between adjacent lens groups change during changing magnification, the subsequent group includes a focusing group that moves along an optical axis during focusing, and in a case where: a focal length of the first lens group is represented by f1, and a focal length of the zoom lens in a state where an infinite distance object at a telephoto end is in focus is represented by ft, Conditional Expression (1) is satisfied: 0.4<f1/ft<1 (1).

### CROSS-REFERENCE TO RELATED APPLICATIONS

This application claims priority from Japanese Application No. 2024-217106, filed on Dec. 11, 2024, the entire disclosure of which is incorporated herein by reference.

### BACKGROUND

### Technical Field

The present disclosed technology relates to a zoom lens and an imaging apparatus.

### Related Art

In the related art, as a zoom lens that can be used in an imaging apparatus, for example, an electronic camera such as a digital camera, a video camera, a broadcast camera, a movie camera, or a surveillance camera, zoom lenses described in JP2019-040020A and JP2015-156010A and are known.

A zoom lens that is configured to be small-sized and has a high magnification has been demanded. A level of the demand has increased year by year.

### SUMMARY

The present disclosure provides a zoom lens where a reduction in size and an increase in magnification are achieved and an imaging apparatus including the zoom lens.

According to one aspect of the present disclosure, there is provided a zoom lens consisting of a first lens group having a positive refractive power, a second lens group having a positive refractive power, a third lens group having a negative refractive power, a fourth lens group, and a subsequent group consisting of two or more lens groups in order from an object side to an image side, in which all of spacings between adjacent lens groups change during changing magnification, the subsequent group includes a focusing group that moves along an optical axis during focusing, and in a case where a focal length of the first lens group is represented by f1 and a focal length of the zoom lens in a state where an infinite distance object at a telephoto end is in focus is represented by ft,
Conditional Expression (1) represented by

$$0.4 < f 1 / ft < 1 \qquad ( 1 )$$

is satisfied.

In the zoom lens according to the above-described aspect,
it is preferable that Conditional Expression (1-1) represented by

$$0.5 < f 1 / ft < 0.9 \qquad ( 1 - 1 )$$

is satisfied.

In the zoom lens according to the above-described aspect, in a case where an open F-number in a state where the infinite distance object at the telephoto end is in focus is represented by FNo, a lateral magnification of the second lens group in a state where the infinite distance object at the telephoto end is in focus is represented by β2, a combined lateral magnification of all lenses closer to the image side than the second lens group in a state where the infinite distance object at the telephoto end is in focus is represented by β2R, a lateral magnification of the third lens group in a state where the infinite distance object at the telephoto end is in focus is represented by β3, a combined lateral magnification of all lenses closer to the image side than the third lens group in a state where the infinite distance object at the telephoto end is in focus is represented by β3R, and
S2 and S3 represented by

$$S 2 = ( 1 - {β2}^{2} ) \times β 2 {R}^{2} , and$$

$$S 3 = ( 1 - {β3}^{2} ) \times β 3 {R}^{2}$$

are defined,
it is preferable that Conditional Expression (2) is satisfied, and it is more preferable that Conditional Expression (2-1) is satisfied.

$$0.1 < \vert S 2 + S 3 \vert / FNo < 0.7 \qquad ( 2 )$$

$$0.2 < \vert S 2 + S 3 \vert / FNo < 0 \text{.65} \qquad ( 2 - 1 )$$

In the zoom lens according to the above-described aspect, it is preferable that, in a case where a focal length of the second lens group is represented by f2,
Conditional expression (3) represented by

$$1.02 < f 1 / f 2 < 2 \qquad ( 3 )$$

is satisfied.

In the zoom lens according to the above-described aspect, it is preferable that, in a case where a minimum value of refractive indices of all lenses in the third lens group with respect to a d line is represented by N3 min,
Conditional Expression (4) represented by

$$1.65 < N 3 min < 1.95 \qquad ( 4 )$$

is satisfied.

In the zoom lens according to the above-described aspect, in a case where an average value of partial dispersion ratios of all positive lenses in the third lens group between a g line and F line is represented by θgFp,
it is preferable that Conditional Expression (5) is satisfied, and it is more preferable that Conditional Expression (5-1) is satisfied.

$$0.615 < θ gFp < 0.66 \qquad ( 5 )$$

$$0.62 < θ gFp < 0 \text{.65} \qquad ( 5 - 1 )$$

It is preferable that the zoom lens according to the above-described aspect, further comprises at least one negative lens that satisfies Conditional Expression (6),
in which in a case where a refractive index of a negative lens in the first lens group with respect to a d line is represented by N1n,
Conditional Expression (6) is represented by

$$1.85 < N 1 n < 2.15 . \qquad ( 6 )$$

It is preferable that the zoom lens according to the above-described aspect further comprises at least one positive lens that satisfies Conditional Expression (7),
in which in a case where an Abbe number of a positive lens in the second lens group with respect to a d line is represented by v2p,
Conditional Expression (7) is represented by

$$65 < v 2 p < 99. \qquad ( 7 )$$

In the zoom lens according to the above-described aspect, it is preferable that, in a case where a focal length of the third lens group is represented by f3,
Conditional expression (8) represented by

$$- 15 < f 1 / f 3 < - 10 \qquad ( 8 )$$

is satisfied.

In the zoom lens according to the above-described aspect, it is preferable that, in a case where a difference in an optical axis direction between a position of the second lens group in a state where the infinite distance object at a wide angle end is in focus and a position of the second lens group in a state where the infinite distance object at the telephoto end is in focus is represented by D2, and a difference in the optical axis direction between a position of the third lens group in a state where the infinite distance object at the wide angle end is in focus and a position of the third lens group in a state where the infinite distance object at the telephoto end is in focus is represented by D3,
Conditional Expression (9) represented by

$$2 < D 3 / D 2 < 3 \qquad ( 9 )$$

is satisfied.

It is preferable that the fourth lens group has a positive refractive power.

It is preferable that the focusing group has a positive refractive power.

In the zoom lens according to above-described aspect, it is preferable that, in a case where a focal length of the fourth lens group is represented by f4, and a focal length of the focusing group is represented by fF,
Conditional Expression (10) represented by

$$1.8 < f 4 / fF < 3 \qquad ( 10 )$$

is satisfied.

It is preferable that the first lens group is fixed relative to an image plane during changing magnification.

It is preferable that the second lens group consists of one positive lens.

It is preferable that the focusing group includes at least one aspherical lens.

It is preferable that the third lens group includes at least three negative lenses.

According to another aspect of the present disclosure, there is provided an imaging apparatus comprising the zoom lens according to the above-described aspect.

In the present specification, it should be noted that the terms “consisting of” and “consists of” mean that the lens may include not only the above-mentioned components but also lenses substantially having no refractive powers, optical elements other than lenses, such as a stop, a filter, and cover glass, and mechanism parts such as a lens flange, a lens barrel, an imaging element, and a camera shaking correction mechanism.

“Group that has a positive refractive power” and “group has a positive refractive power” represent that the group as a whole has a positive refractive power. “Group that has a negative refractive power” means that the group has a negative refractive power as a whole. “Lens having a positive refractive power” and the term “positive lens” are synonymous with each other. “Lens that has a negative refractive power” and the term “negative lens” are synonymous. “˜Lens group” and “focusing group” are not limited to a configuration consisting of a plurality of lenses, but may consist of only one lens.

The number of lenses described above is the number of lenses as components. For example, it is assumed that the number of lenses in a cemented lens in which a plurality of single lenses made of different materials are cemented is represented by the number of single lenses constituting the cemented lens. Here, a compound aspherical lens (that is, a lens (for example, a spherical lens) and an aspherical film formed on the lens are integrated and function as one aspherical lens as a whole) is not regarded as a cemented lens, but the compound aspherical lens is regarded as one lens. The sign of the refractive power and the surface shape relating to an optical member including an aspheric surface are considered in a paraxial region unless otherwise specified.

The “focal length” used in a conditional expression is a paraxial focal length. Unless otherwise specified, values used in the conditional expressions are values based on the d line in a state where the infinite distance object is in focus. “d line”, “C line”, “F line”, and “g line” described in the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, it is possible to provide a zoom lens where a reduction in size and an increase in magnification are achieved and an imaging apparatus including the zoom lens.

### BRIEF DESCRIPTION OF THE DRAWINGS

FIG. 1 is a diagram showing a configuration of a zoom lens according to an embodiment and movement loci thereof, the zoom lens corresponding to a zoom lens according to Example 1.

FIG. 2 is a cross sectional view showing a configuration of the zoom lens according to Example 1 at a wide angle end.

FIG. 3 shows each of aberration diagrams in the zoom lens according to Example 1.

FIG. 4 is a diagram showing a configuration of a zoom lens according to Example 2 and movement loci thereof.

FIG. 5 shows each of aberration diagrams in the zoom lens according to Example 2.

FIG. 6 is a diagram showing a configuration of a zoom lens according to Example 3 and movement loci thereof.

FIG. 7 shows each of aberration diagrams in the zoom lens according to Example 3.

FIG. 8 is a diagram showing a configuration of a zoom lens according to Example 4 and movement loci thereof.

FIG. 9 shows each of aberration diagrams in the zoom lens according to Example 4.

FIG. 10 is a diagram showing a configuration of a zoom lens according to Example 5 and movement loci thereof.

FIG. 11 shows each of aberration diagrams in the zoom lens according to Example 5.

FIG. 12 is a diagram showing a configuration of a zoom lens according to Example 6 and movement loci thereof.

FIG. 13 shows each of aberration diagrams in the zoom lens according to Example 6.

FIG. 14 is a diagram showing a configuration of a zoom lens according to Example 7 and movement loci thereof.

FIG. 15 shows each of aberration diagrams in the zoom lens according to Example 7.

FIG. 16 is a diagram showing a configuration of a zoom lens according to Example 8 and movement loci thereof.

FIG. 17 shows each of aberration diagrams in the zoom lens according to Example 8.

FIG. 18 is a schematic configuration diagram showing an imaging apparatus according to an embodiment.

FIG. 19 is a perspective view of a front side of the imaging apparatus according to the embodiment.

FIG. 20 is a perspective view showing a rear side of the imaging apparatus according to the embodiment.

### DETAILED DESCRIPTION

Hereinafter, embodiments of the present disclosure will be described with reference to the accompanying drawings.

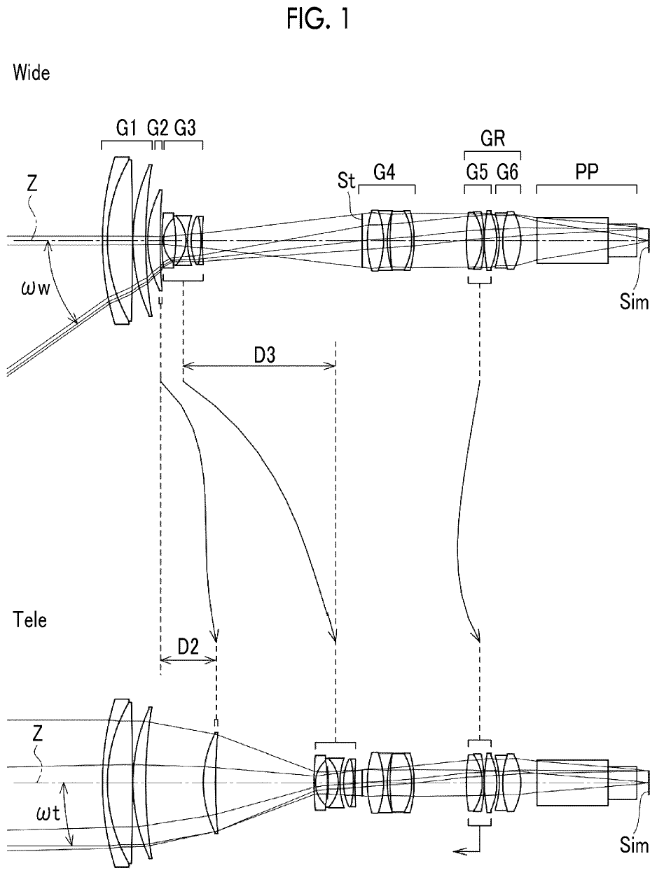

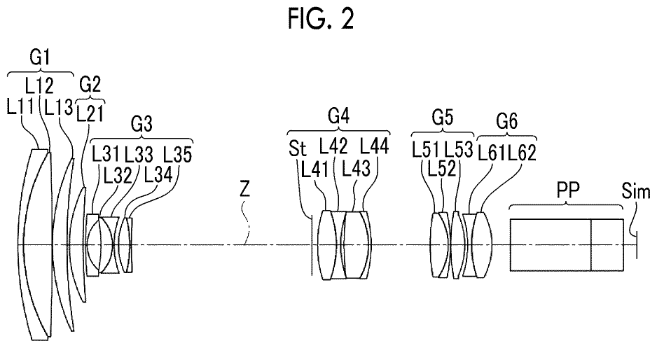

FIG. 1 is a cross sectional view showing a configuration of a zoom lens according to an embodiment of the present disclosure and luminous fluxes and movement loci thereof. In FIG. 1, the upper part to which “Wide” is added shows a wide angle end state, and the lower part to which “Tele” is added shows a telephoto end state. As luminous fluxes, FIG. 1 shows an on-axis luminous flux and a luminous flux having a maximum half angle of view ow at a wide angle end, and an on-axis luminous flux and a luminous flux having a maximum half angle of view to at a telephoto end. FIG. 2 shows a cross sectional view of the configuration of the zoom lens of FIG. 1 at the wide angle end. FIGS. 1 and 2 show a state where an infinite distance object is in focus, in which the left side is an object side and the right side is an image side. The example of FIGS. 1 and 2 corresponds to the zoom lens according to Example 1 below. The following description will be made main with reference to FIG. 1 and optionally with reference to FIG. 2.

FIG. 1 shows an example in which, assuming that a zoom lens is applied to an imaging apparatus, an optical member PP having a parallel plate shape is disposed between the zoom lens and an image plane Sim. The optical member PP is a member assumed to include, for example, various filters and/or cover glass. The various filters include a low pass filter, an infrared cut filter, and/or a filter that cuts a specific wavelength range. The optical member PP is a member that has no refractive power. The imaging apparatus can also be configured without including the optical member PP.

The zoom lens according to the present disclosure consists of a first lens group G1 having a positive refractive power, a second lens group G2 having a positive refractive power, a third lens group G3 having a negative refractive power, a fourth lens group G4, and a subsequent group GR consisting of two or more lenses in order from the object side to the image side. All of spacings between adjacent lens groups change during changing magnification. By setting the first lens group G1 that is closest to the object side as a lens group having a positive refractive power, a reduction in the total length of the lens system is facilitated, which is advantageous in reducing the size. By setting the second lens group G2 as a lens group having a positive refractive power and changing spacings of the second lens group G2 on the object side and the image side during changing magnification, an increase in the effective diameter of the first lens group G1 on the telephoto side can be suppressed. As a result, an increase in the outer diameter of the first lens group G1 can be suppressed, and thus a reduction in size is achieved. In particular, portability is required for a movie camera, a broadcast camera, or the like, and thus it is effective to reduce the size of the first lens group G1 of which the lens diameter is likely to increase. In addition, by moving a plurality of lens groups during changing magnification, an increase in magnification is facilitated.

In the present specification, one lens group is a group of which a spacing to an adjacent group in an optical axis direction changes during changing magnification. During changing magnification, a spacing between adjacent lenses does not change in one lens group. That is, “lens group” is a component part of the zoom lens, and is a part including at least one lens divided by an air spacing that changes during changing magnification. During changing magnification, the lens group moves or is fixed in each lens group unit. “Lens group” may include a component having no refractive power other than a lens, for example, an aperture stop St.

The subsequent group GR includes a focusing group that moves along an optical axis Z during focusing. By disposing the focusing group in the subsequent group GR, the effective diameter of the focusing group can be reduced, which is advantageous in reducing the size of the focusing group unit.

For example, the zoom lens of FIG. 1 consists of the first lens group G1, the second lens group G2, the third lens group G3, the fourth lens group G4, a fifth lens group G5, and a sixth lens group G6 in order from the object side to the image side. In the example of FIG. 1, the subsequent group GR consists of the fifth lens group G5 and the sixth lens group G6.

For example, each lens group of FIG. 1 is configured as follows as in the detailed configuration shown in FIG. 2. The first lens group G1 consists of three lenses including lenses L11 to L13 in order from the object side to the image side. The second lens group G2 consists of one lens L21. The third lens group G3 consists of five lenses including lenses L31 to L35 in order from the object side to the image side. The fourth lens group G4 consists of the aperture stop St and four lenses including lenses L41 to L44 in order from the object side to the image side. The fifth lens group G5 consists of three lenses including lenses L51 to L53 in order from the object side to the image side. The sixth lens group G6 consists of two lenses including lenses L61 and L62 in order from the object side to the image side. The aperture stop St of FIGS. 1 and 2 does not indicate the shape or the size thereof, but indicates the position thereof in the optical axis direction.

For example, in the zoom lens of FIG. 1, the first lens group G1, the fourth lens group G4, and the sixth lens group G6 are fixed relative to the image plane Sim during changing magnification. In addition, the second lens group G2, the third lens group G3, and the fifth lens group G5 move along the optical axis Z during changing magnification. Regarding each lens group that moves during changing magnification, a schematic movement locus during changing magnification from the wide angle end to the telephoto end is indicated by a solid line arrow between the upper part diagram and the lower part diagram in FIG. 1.

For example, in the zoom lens of FIG. 1, the focusing group consists of the fifth lens group G5. A parenthesis and a left arrow added to the fifth lens group G5 of the lower part diagram of FIG. 1 represent that lenses in the parenthesis configure the focusing group and a direction in which the focusing group moves during focusing from an infinite distance object to a close distance object, respectively. The focusing group functions throughout the entire changing magnification range including the wide angle end state, but in FIG. 1, the arrow is added only in the lower part drawing in order to avoid complication of the drawing.

It is preferable that the first lens group G1 is fixed relative to the image plane Sim during changing magnification. By fixing the first lens group G1 during changing magnification, the centroid movement during changing magnification can be suppressed without a change in the total length of the lens system.

It is preferable that the second lens group G2 consists of one positive lens. In this case, this configuration is advantageous in reducing the weight of the second lens group G2. In addition, the thickness of the second lens group G2 can be suppressed, and thus the movement amount during changing magnification can be ensured, which is advantageous in increasing the magnification.

It is preferable that the third lens group G3 includes at least three negative lenses. In this case, this configuration is advantageous in suppressing fluctuations in chromatic aberration during changing magnification.

It is preferable that the third lens group G3 includes at least two positive lenses. In this case, this configuration is advantageous in suppressing fluctuations in chromatic aberration during changing magnification.

It is preferable that the fourth lens group G4 has a positive refractive power. In this case, the effective diameter of the focusing group disposed in the subsequent group GR closer to the image side than the fourth lens group G4 can be suppressed, which is advantageous in reducing the size of the focusing group unit.

It is preferable that the fourth lens group G4 is fixed relative to the image plane Sim during changing magnification. In this case, the number of lens groups that move during changing magnification can be reduced, which is advantageous in suppressing defocus during changing magnification.

It is preferable that the lens group closest to the image side is fixed relative to the image plane Sim during changing magnification. In this case, the number of lens groups that move during changing magnification can be reduced, which is advantageous in suppressing defocus during changing magnification.

It is preferable that the focusing group has a positive refractive power. In this case, an increase in an angle at which an off-axis principal ray is incident into the image plane Sim can be suppressed, which is advantageous in suppressing shading. In addition, this configuration is advantageous in ensuring back focus.

It is preferable that the focusing group includes at least one aspherical lens. In this case, this configuration is advantageous in suppressing fluctuations in aberrations during focusing.

The focusing group may be configured to consist of one lens group that moves during changing magnification. In this case, this configuration is advantageous in simplifying the moving mechanism.

The zoom lens according to the present disclosure may be configured to consist of six lens groups having a positive refractive power, a positive refractive power, a negative refractive power, a positive refractive power, a positive refractive power, and a negative refractive power in order from the object side to the image side, and the focusing group may be configured to consist of the fifth lens group G5. This way, by allowing the sixth lens group G6 closest to the image side to have a negative refractive power, the enhancement of the positive refractive power of the fifth lens group G5 that moves during focusing is facilitated. Accordingly, this configuration is advantageous in reducing the close distance at the telephoto end. Examples 1 and 2 and 4 to 6 described below correspond to this configuration.

In addition, the zoom lens according to the present disclosure may be configured to consist of six lens groups having a positive refractive power, a positive refractive power, a negative refractive power, a positive refractive power, a positive refractive power, and a positive refractive power in order from the object side to the image side, and the focusing group may be configured to consist of the fifth lens group G5. This way, by allowing the sixth lens group G6 closest to the image side to have a positive refractive power, the weakening of the positive refractive power of the fifth lens group G5 that moves during focusing is facilitated. Accordingly, the focus sensitivity of the focusing group is likely to be suppressed, which is advantageous in suppressing defocus during focusing. Examples 3 and 8 described below correspond to this configuration.

The zoom lens according to the present disclosure may be configured to consist of seven lens groups having a positive refractive power, a positive refractive power, a negative refractive power, a positive refractive power, a negative refractive power, a positive refractive power, and a negative refractive power in order from the object side to the image side. This way, the subsequent group GR includes two lens groups that move during changing magnification, which is advantageous in suppressing fluctuations in field curvature during changing magnification in a middle zoom range. Example 7 described below corresponds to this configuration.

Next, preferable and possible configurations about conditional expressions of the zoom lens according to the present disclosure will be described. In the following description relating to the conditional expressions, in order to avoid redundant description, factors having the same definition will be represented by the same symbols, and the description thereof will not be repeated. Further, hereinafter, “the zoom lens according to the present disclosure” will also be simply referred to as “the zoom lens” in order to avoid redundant description.

In a case where a focal length of the first lens group G1 is represented by f1 and a focal length of the zoom lens in a state where the infinite distance object at the telephoto end is in focus is represented by ft, it is preferable that the zoom lens satisfies Conditional Expression (1). By setting the corresponding value of Conditional Expression (1) not to be the lower limit value or less, the refractive power of the first lens group G1 is not excessively strong, which is advantageous in suppressing aberrations generated in the first lens group G1, in particular, spherical aberration at the telephoto end. By setting the corresponding value of Conditional Expression (1) not to be the upper limit value or more, the refractive power of the first lens group G1 is not excessively weak, and the height from optical axis Z of a ray incident into the second lens group G2 can be reduced, which is advantageous in reducing the size of the optical system.

$$0.4 < f 1 / ft < 1 \qquad ( 1 )$$

In order to obtain more favorable characteristics, the lower limit value of Conditional Expression (1) is more preferably 0.5, still more preferably 0.55, and still more preferably 0.6. In order to obtain more favorable characteristics, the upper limit value of Conditional Expression (1) is more preferably 0.9, still more preferably 0.85, and still more preferably 0.75. For example, it is more preferable that the zoom lens satisfies Conditional Expression (1-1), it is still more preferable that the zoom lens satisfies Conditional Expression (1-2), and it is still more preferable that the zoom lens satisfies Conditional Expression (1-3).

$$0.5 < f 1 / ft < 0.9 \qquad ( 1 - 1 )$$

$$0.55 < f 1 / ft < 0.85 \qquad ( 1 - 2 )$$

$$0.6 < f 1 / ft < 0.75 \qquad ( 1 - 3 )$$

It is preferable that the zoom lens satisfies Conditional Expression (2). Here, an open F-number in a state where the infinite distance object at the telephoto end is in focus is represented by FNo. A lateral magnification of the second lens group G2 in a state where the infinite distance object at the telephoto end is in focus is represented by β2. A combined lateral magnification of all lenses closer to the image side than the second lens group G2 in a state where the infinite distance object at the telephoto end is in focus is represented by β2R. A lateral magnification of the third lens group G3 in a state where the infinite distance object at the telephoto end is in focus is represented by β3. A combined lateral magnification of all lenses closer to the image side than the third lens group G3 in a state where the infinite distance object at the telephoto end is in focus is represented by β3R. S2 and S3 represented by the following expressions are defined.

$$S 2 = ( 1 - {β2}^{2} ) \times β2 {R}^{2}$$

$$S 3 = ( 1 - {β3}^{2} ) \times β3 {R}^{2}$$

S2 represents a movement amount (so-called, focus sensitivity) of an image plane position relative to a unit movement amount of the second lens group G2 in a state where the infinite distance object at the telephoto end is in focus. Likewise, S3 represents a focus sensitivity of the third lens group G3 in a state where the infinite distance object at the telephoto end is in focus. By setting the corresponding value of Conditional Expression (2) not to be the lower limit or less, this configuration is advantageous in increasing the magnification. By setting the corresponding value of Conditional Expression (2) not to be the upper limit or more, the focus sensitivity of the second lens group G2 and the third lens group G3 can be reduced, which is advantageous in suppressing defocus during changing magnification.

$$0.1 < \vert S 2 + S 3 \vert / FNo < 0.7 \qquad ( 2 )$$

In order to obtain more favorable characteristics, the lower limit value of Conditional Expression (2) is more preferably 0.2, still more preferably 0.3, and still more preferably 0.4. In order to obtain more favorable characteristics, the upper limit value of Conditional Expression (2) is more preferably 0.65, still more preferably 0.6, and still more preferably 0.55. For example, it is more preferable that the zoom lens satisfies Conditional Expression (2-1), it is still more preferable that the zoom lens satisfies Conditional Expression (2-2), and it is still more preferable that the zoom lens satisfies Conditional Expression (2-3).

$$0.2 < \vert S 2 + S 3 \vert / FNo < 0.65 \qquad ( 2 - 1 )$$

$$0.3 < \vert S 2 + S 3 \vert / FNo < 0.6 \qquad ( 2 - 2 )$$

$$0.4 < \vert S 2 + S 3 \vert / FNo < 0.55 \qquad ( 2 - 3 )$$

In a case where a focal length of the second lens group G2 is represented by f2, it is preferable that the zoom lens satisfies Conditional Expression (3). By setting the corresponding value of Conditional Expression (3) not to be the lower limit value or less, the refractive power of the first lens group G1 is not excessively strong, which is advantageous in suppressing aberrations generated in the first lens group G1, in particular, spherical aberration at the telephoto end. By setting the corresponding value of Conditional Expression (3) not to be the upper limit value or more, the refractive power of the first lens group G1 is not excessively weak, and the height from optical axis Z of a ray incident into the second lens group G2 can be reduced, which is advantageous in reducing the size of the optical system.

$$1.02 < f 1 / f 2 < 2 \qquad ( 3 )$$

In order to obtain more favorable characteristics, the lower limit value of Conditional Expression (3) is more preferably 1.05, still more preferably 1.07, and still more preferably 1.1. In order to obtain more favorable characteristics, the upper limit value of Conditional Expression (3) is more preferably 1.5, still more preferably 1.4, and still more preferably 1.3. For example, it is more preferable that the zoom lens satisfies Conditional Expression (3-1), it is still more preferable that the zoom lens satisfies Conditional Expression (3-2), and it is still more preferable that the zoom lens satisfies Conditional Expression (3-3).

$$1.05 < f 1 / f 2 < 1.5 \qquad ( 3 - 1 )$$

$$1.07 < f 1 / f 2 < 1.4 \qquad ( 3 - 2 )$$

$$1.1 < f 1 / f 2 < 1.3 \qquad ( 3 - 3 )$$

In a case where a minimum value of refractive indices of all lenses in the third lens group G3 with respect to a d line is represented by N3 min, it is preferable that the zoom lens satisfies Conditional Expression (4). By setting the corresponding value of Conditional Expression (4) not to be the lower limit value or less, the refractive powers of the lenses in the third lens group G3 are not excessively weak, which is advantageous in increasing the magnification. By setting the corresponding value of Conditional Expression (4) not to be the upper limit value or more, a material having a small dispersion can be selected for the lenses in the third lens group G3, which is advantageous in suppressing fluctuations in chromatic aberration during changing magnification.

$$1.65 < N 3 min < 1.95 \qquad ( 4 )$$

In order to obtain more favorable characteristics, the lower limit value of Conditional Expression (4) is more preferably 1.7 and still more preferably 1.75. In order to obtain more favorable characteristics, the upper limit value of Conditional Expression (4) is more preferably 1.9 and still more preferably 1.85. For example, it is more preferable that the zoom lens satisfies Conditional Expression (4-1), and it is still more preferable that the zoom lens satisfies Conditional Expression (4-2).

$$1.7 < N 3 min < 1.9 \qquad ( 4 - 1 )$$

$$1.75 < N 3 min < 1.85 \qquad ( 4 - 2 )$$

In a case where an average value of partial dispersion ratios of all positive lenses in the third lens group G3 between a g line and an F line is represented by θgFp, it is preferable that the zoom lens satisfies Conditional Expression (5). By setting the corresponding value of Conditional expression (5) to be in the range of Conditional Expression (5), a material having an appropriate anomalous dispersion can be selected for the positive lens in the third lens group G3, which is advantageous in suppressing fluctuations in chromatic aberration during changing magnification.

$$0.615 < θ gFp < 0.66 \qquad ( 5 )$$

In order to obtain more favorable characteristics, the lower limit value of Conditional Expression (5) is more preferably 0.62 and still more preferably 0.625. In order to obtain more favorable characteristics, the upper limit value of Conditional Expression (5) is more preferably 0.65 and still more preferably 0.64. For example, it is more preferable that the zoom lens satisfies Conditional Expression (5-1), and it is still more preferable that the zoom lens satisfies Conditional Expression (5-2).

$$0.62 < θ gFp < 0.65 \qquad ( 5 - 1 )$$

$$0.625 < θ gFp < 0.64 \qquad ( 5 - 2 )$$

In a case where refractive indices of one lens with respect to the g line, the F line, and the C line are represented by Ng, NF, and NC, respectively, and a partial dispersion ratio of the lens between the g line and the F line is represented by θgF, θgF is defined by the following expression.

$$θ gF = ( Ng - NF ) / ( NF - NC )$$

It is preferable that the zoom lens includes at least one negative lens that satisfies Conditional Expression (6). Here, a refractive index of a negative lens in the first lens group G1 with respect to the d line is represented by N1n. By setting the corresponding value of Conditional Expression (6) not to be the lower limit value or less, which is advantageous in suppressing aberrations generated in the first lens group G1, in particular, spherical aberration at the telephoto end and the astigmatism at the wide angle end. By setting the corresponding value of Conditional Expression (6) not to be the upper limit value or more, a material having a high transmittance can be selected for the negative lens in the first lens group G1.

$$1.85 < N 1 n < 2.15 \qquad ( 6 )$$

In order to obtain more favorable characteristics, the lower limit value of Conditional Expression (6) is more preferably 1.95 and still more preferably 2. In order to obtain more favorable characteristics, the upper limit value of Conditional Expression (6) is more preferably 2.1 and still more preferably 2.07. For example, it is more preferable that the zoom lens includes at least one negative lens that satisfies Conditional Expression (6-1), and it is still more preferable that the zoom lens includes at least one negative lens that satisfies Conditional Expression (6-2).

$$1.95 < N 1 n < 2.1 \qquad ( 6 - 1 )$$

$$2 < N 1 n < 2.07 \qquad ( 6 - 2 )$$

It is preferable that the zoom lens includes at least one positive lens that satisfies Conditional Expression (7). Here, an Abbe number of a positive lens in the second lens group G2 with respect to the d line is represented by v2p. By setting the corresponding value of Conditional Expression (7) not to be the lower limit value or less, this configuration is advantageous in suppressing axial chromatic aberration at the telephoto end. By setting the corresponding value of Conditional Expression (7) not to be the upper limit value or more, a material having a high refractive index can be selected for the positive lens in the second lens group G2. Therefore, the refractive power of the second lens group G2 can be increased, which is advantageous in reducing the size of the optical system.

$$65 < v 2 p < 99 \qquad ( 7 )$$

In order to obtain more favorable characteristics, the lower limit value of Conditional Expression (7) is more preferably 70 and still more preferably 75. In order to obtain more favorable characteristics, the upper limit value of Conditional Expression (7) is more preferably 95 and still more preferably 91. For example, it is more preferable that the zoom lens includes at least one positive lens that satisfies Conditional Expression (7-1), and it is still more preferable that the zoom lens includes at least one positive lens that satisfies Conditional Expression (7-2).

$$70 < v 2 p < 95 \qquad ( 7 - 1 )$$

$$75 < v 2 p < 91 \qquad ( 7 - 2 )$$

In a case where a focal length of the third lens group G3 is represented by f3, it is preferable that the zoom lens satisfies Conditional Expression (8). By setting the corresponding value of Conditional Expression (8) not to be the lower limit value or less, the refractive power of the third lens group G3 is not excessively strong, which is advantageous in suppressing fluctuations in aberrations during changing magnification. By setting the corresponding value of Conditional Expression (8) not to be the upper limit value or more, the refractive power of the third lens group G3 is not excessively weak. Therefore, the movement amount of the third lens group G3 during changing magnification can be suppressed, which is advantageous in reducing the total length of the lens system.

$$- 15 < f 1 / f 3 < - 10 \qquad ( 8 )$$

In order to obtain more favorable characteristics, the lower limit value of Conditional Expression (8) is more preferably −14 and still more preferably −13.5. In order to obtain more favorable characteristics, the upper limit value of Conditional Expression (8) is more preferably −11 and still more preferably −12. For example, it is more preferable that the zoom lens satisfies Conditional Expression (8-1), and it is still more preferable that the zoom lens satisfies Conditional Expression (8-2).

$$- 14 < f 1 / f 3 < - 11 \qquad ( 8 - 1 )$$

$$- 13.5 < f 1 / f 3 < - 12 \qquad ( 8 - 2 )$$

It is preferable that the zoom lens satisfies Conditional Expression (9). Here, a difference in the optical axis Z direction between a position of the second lens group G2 in a state where the infinite distance object at the wide angle end is in focus and a position of the second lens group G2 in a state where the infinite distance object at the telephoto end is in focus is represented by D2. A difference in the optical axis Z direction between a position of the third lens group G3 in a state where the infinite distance object at the wide angle end is in focus and a position of the third lens group G3 in a state where the infinite distance object at the telephoto end is in focus is represented by D3. FIG. 1 shows D2 and D3. By setting the corresponding value of Conditional Expression (9) not to be the lower limit value or less, the movement amount of the second lens group G2 during changing magnification can be suppressed, which is advantageous in suppressing fluctuations of aberrations during changing magnification, in particular, fluctuations of spherical aberration at the telephoto end. By setting the corresponding value of Conditional Expression (9) not to be the upper limit value or more, the movement amount of the third lens group G3 during changing magnification can be suppressed, which is advantageous in reducing the size of the optical system.

$$2 < D 3 / D 2 < 3 \qquad ( 9 )$$

In order to obtain more favorable characteristics, the lower limit value of Conditional Expression (9) is more preferably 2.2 and still more preferably 2.5. In order to obtain more favorable characteristics, the upper limit value of Conditional Expression (9) is more preferably 2.9 and still more preferably 2.8. For example, it is more preferable that the zoom lens satisfies Conditional Expression (9-1), and it is still more preferable that the zoom lens satisfies Conditional Expression (9-2).

$$2.2 < D 3 / D 2 < 2.9 \qquad ( 9 - 1 )$$

$$2.5 < D 3 / D 2 < 2.8 \qquad ( 9 - 2 )$$

In a case where a focal length of the fourth lens group G4 is represented by f4 and a focal length of the focusing group is represented by fF, It is preferable that the zoom lens satisfies Conditional Expression (10). By setting the corresponding value of Conditional Expression (10) not to be the lower limit value or less, the refractive power of the focusing group is not excessively weak. Therefore, the movement amount during focusing is likely to be suppressed, which is advantageous in reducing the total length of the lens system. By setting the corresponding value of Conditional Expression (10) not to be the upper limit value or more, the refractive power of the focusing group is not excessively strong, which is advantageous in suppressing fluctuations in aberrations during focusing.

$$1.8 < f 4 / fF < 3 \qquad ( 10 )$$

In order to obtain more favorable characteristics, the lower limit value of Conditional Expression (10) is more preferably 1.85 and still more preferably 1.9. In order to obtain more favorable characteristics, the upper limit value of Conditional Expression (10) is more preferably 2.8 and still more preferably 2.7. For example, it is more preferable that the zoom lens satisfies Conditional Expression (10-1), and it is still more preferable that the zoom lens satisfies Conditional Expression (10-2).

$$1.85 < f 4 / fF < 2.8 \qquad ( 10 - 1 )$$

$$1.9 < f 4 / fF < 2.7 \qquad ( 10 - 2 )$$

In a case where a lateral magnification of the third lens group in a state where the infinite distance object at the wide angle end is in focus is represented by β3w, it is preferable that the zoom lens satisfies Conditional Expression (11). By setting the corresponding value of Conditional Expression (11) not to be the lower limit value or less, the magnification changing action of the third lens group G3 is not excessively weak, which is advantageous in increasing the magnification. By setting the corresponding value of Conditional Expression (11) not to be the upper limit value or more, the magnification changing action of the third lens group G3 is not excessively strong, which is advantageous in suppressing fluctuations in aberrations during changing magnification.

$$20 < β3 / β3 w < 40 \qquad ( 11 )$$

In order to obtain more favorable characteristics, the lower limit value of Conditional Expression (11) is more preferably 23 and still more preferably 25. In order to obtain more favorable characteristics, the upper limit value of Conditional Expression (11) is more preferably 35 and still more preferably 30. For example, it is more preferable that the zoom lens satisfies Conditional Expression (11-1), and it is still more preferable that the zoom lens satisfies Conditional Expression (11-2).

$$23 < β3 / β3 w < 35 \qquad ( 11 - 1 )$$

$$25 < β3 / β3 w < 30 \qquad ( 11 - 2 )$$

It is preferable that the zoom lens satisfies Conditional Expression (12). Here, an open F-number in a state where the infinite distance object at the wide angle end is in focus is represented by FNow. A lateral magnification of the focusing group in a state where the infinite distance object at the wide angle end is in focus is represented by βFw. A combined lateral magnification of all lenses closer to the image side than the focusing group in a state where the infinite distance object at the wide angle end is in focus is represented by βFRw. SFw represented by the following expression is defined.

$$SFw = ( 1 - β {Fw}^{2} ) \times β {FRw}^{2}$$

SFw represents a movement amount (so-called, focus sensitivity) of an image plane position relative to a movement amount of the focusing group during focusing. By setting the corresponding value of Conditional Expression (12) not to be the lower limit or less, the movement amount of the focusing group during focusing is likely to be suppressed, which is advantageous in reducing the total length of the lens system. By setting the corresponding value of Conditional Expression (12) not to be the upper limit or more, the focus sensitivity of the focusing group is likely to be suppressed, which is advantageous in suppressing defocus during focusing.

$$0.5 < SFw / FNow < 1.2 \qquad ( 12 )$$

In order to obtain more favorable characteristics, the lower limit value of Conditional Expression (12) is more preferably 0.7 and still more preferably 0.9. In order to obtain more favorable characteristics, the upper limit value of Conditional Expression (12) is more preferably 1.1 and still more preferably 1. For example, it is more preferable that the zoom lens satisfies Conditional Expression (12-1), and it is still more preferable that the zoom lens satisfies Conditional Expression (12-2).

$$0.7 < SFw / FNow < 1.1 \qquad ( 12 - 1 )$$

$$0.9 < SFw / FNow < 1 \qquad ( 12 - 2 )$$

In a configuration where the focusing group moves to the object side during focusing from the infinite distance object to the close distance object, it is preferable that the zoom lens satisfies Conditional Expression (13). Here, an air spacing on the optical axis Z between a lens adjacent to the object side in the focusing group and the focusing group in a state where the infinite distance object at the telephoto end is in focus is represented by dFf. The sum of a distance on the optical axis Z from a lens surface closest to the object side in the first lens group G1 to a lens surface closest to the image side in the subsequent group GR in a state where the infinite distance object at the telephoto end is in focus, and a back focus of the zoom lens in terms of an air conversion distance is represented by TL. By setting the corresponding value of Conditional Expression (13) not to be the lower limit value or less, a space where the focusing group moves during focusing can be ensured, which is advantageous in reducing the close distance. By setting the corresponding value of Conditional Expression (13) not to be the upper limit value or more, a space where the focusing group moves during focusing is not excessively large, which is advantageous in reducing the size of the optical system.

$$0.05 < dFf / TL < 0.2 \qquad ( 13 )$$

In order to obtain more favorable characteristics, the lower limit value of Conditional Expression (13) is more preferably 0.08 and still more preferably 0.1. In order to obtain more favorable characteristics, the upper limit value of Conditional Expression (13) is more preferably 0.17 and still more preferably 0.15. For example, it is more preferable that the zoom lens satisfies Conditional Expression (13-1), and it is still more preferable that the zoom lens satisfies Conditional Expression (13-2).

$$0.08 < dFf / TL < 0.17 \qquad ( 13 - 1 )$$

$$0.1 < dFf / TL < 0.15 \qquad ( 13 - 2 )$$

The preferable configurations and available configurations including the configurations regarding the conditional expressions can be freely combined within a range where they do not contradict each other, and it is preferable to appropriately selectively adopt the combination according to required specifications. In addition, for the zoom lens according to the present disclosure, various modifications can be made without departing from the scope of the present disclosed technology. For example, the number of lens groups in the subsequent group GR may be different from the number in the above-described example. The numbers of lens groups in the first lens group G1, the second lens group G2, the third lens group G3, the fourth lens group G4, and the subsequent group GR and the number of lenses in the focusing group may be different from the numbers in the above-described example.

For example, one preferable aspect of the zoom lens according to the present disclosure is a zoom lens consisting of a first lens group G1 having a positive refractive power, a second lens group G2 having a positive refractive power, a third lens group G3 having a negative refractive power, a fourth lens group G4, and a subsequent group GR consisting of two or more lenses in order from the object side to the image side, in which all of spacings between adjacent lens groups change during changing magnification, the subsequent group GR includes a focusing group that moves along the optical axis Z during focusing, and Conditional Expression (1) is satisfied.

Next, examples of the zoom lens according to the present disclosure will be described with reference to the drawings. The reference numerals added to the groups in the cross sectional views of each example are used independently for each example in order to avoid complication of description and drawings due to an increase in number of digits of the reference numerals. Therefore, even in a case where common reference numerals are added in the drawings of different examples, components do not necessarily have a common configuration.

### Example 1

FIG. 1 shows a configuration of a zoom lens according to Example 1 and movement loci thereof, and an illustration method and a configuration thereof are as described above. Therefore, some description is not repeated herein. The zoom lens according to Example 1 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a negative refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

Regarding the zoom lens according to Example 1, Table 1 shows basic lens data, Table 2 shows specifications and variable surface spacings, and Table 3 shows aspherical coefficients.

The table of the basic lens data is described as follows. The “Sn” column shows surface numbers in a case where the surface closest to the object side is the first surface and the number is increased one by one toward the image side. The “R” column shows a curvature radius of each surface. The “D” column shows a surface spacing between each surface and the surface adjacent to the image side on the optical axis. The “Nd” column shows a refractive index of each component with respect to the d line. The “vd” column shows an Abbe number of each component with respect to the d line. The “θgF” column shows a partial dispersion ratio between the g line and the F line in each of the components. The “Material” column shows a material name and a manufacturer name of each of the components with a period interposed therebetween. The manufacturer name is abbreviated. “CDGM” represents CDGM GLASS Co., Ltd., “HIKARI” represents HIKARI GLASS Co., Ltd., “HOYA” represents HOYA Corporation, “NHG” represents Hubei New Huaguang Information Materials Co., Ltd., “OHARA” represents OHARA Inc., “SCHOTT” represents SCHOTT AG, and “SUMITA” represents Sumita Optical Glass Co., Ltd. The “ED” column shows an effective diameter of each surface.

In the table of the basic lens data, the sign of the curvature radius of a surface that is convex to the object side is positive, and the sign of the curvature radius of a surface that is convex to the image side is negative. The table of basic lens data also shows the aperture stop St and the optical member PP. In the fields of the surface number of the surface corresponding to the aperture stop St, the surface number and the expression (St) are shown. A value in the lowermost field of the column of D is a spacing between a surface closest to the image side in the table and the image plane Sim. The symbol DD[ ] is used for the variable surface spacing during changing magnification, and the surface number of the object side of the spacing is given in [ ] and is shown in the column of the surface spacing.

Table 2 shows a zoom ratio Zr, a focal length f, a back focus Bf in terms of an air conversion distance, an open F-number Fno, a maximum total angle of view 2ω, and the variable surface spacing with respect to the d line. The zoom ratio Zr is synonymous with the zoom magnification. [°] in the fields of 2ω indicates that the unit thereof is degree. Tables 2 shows the respective values in the wide angle end state, the middle focal length state, and the telephoto end in a state where the infinite distance object is in focus and in a state where the close distance object is in focus. In the case of the state where the infinite distance object is in focus, “Infinite” is shown in the field of the object distance. In the case of the state where the close distance object is in focus, the object distance to the close distance object is shown in the field of the object distance. The object distance refers to a distance on the optical axis between an object that is a subject of the zoom lens and a lens surface closest to the object side in the zoom lens. Here, f and Bf are shown only for the state where the infinite distance object is in focus. “Wide”, “Middle”, and “Tele” in the field of the changing magnification state represent the wide angle end state, the middle focal length state, and the telephoto end state, respectively.

In the table of the basic lens data, a reference sign * is added to surface numbers of aspherical surfaces, and values of paraxial curvature radius are shown in the fields of the curvature radius of the aspherical surface. In Table 3, the Sn row shows the surface number of the aspherical surface, and the KA and Am rows (where m=3, 4, 5, . . . , and 16) show numerical values of the aspherical coefficients for the aspherical surfaces. The “E±n” (n: an integer) in the numerical values of the aspherical coefficients of Table 3 indicates “×10^{±n}”. KA and Am are the aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where,
Zd is an aspherical surface depth (a length of a perpendicular from a point on an aspherical surface at a height h to a plane that is perpendicular to the optical axis Z and in contact with the aspherical surface apex),
h is a height (a distance from the optical axis Z to the lens surface),
C is a reciprocal of the paraxial curvature radius,
KA and Am are aspherical coefficients, and
Σ in the aspheric equation represents the total sum regarding m.

In the data of each of the tables, degrees are used as the unit of an angle, and millimeters are used as the unit of a length except for the object distance of the table of the specifications. However, appropriate different units may be used because the optical system can be used even in a case where the system is enlarged or reduced in proportion. In addition, each of the following tables shows numerical values rounded off to predetermined decimal places.

TABLE 1
Example 1

| Sn | R | D | Nd | νd | θgF | Material | ED |
|---|---|---|---|---|---|---|---|
| 1 | 131.5918 | 2.3400 | 2.00100 | 29.13 | 0.59935 | H-ZLAF82.NHG | 65.86 |
| 2 | 74.5150 | 11.6400 | 1.43700 | 95.12 | 0.53487 | H-FK95.NHG | 63.91 |
| 3 | −1239.2496 | 0.2000 | | | | | 63.33 |
| 4 | 82.6540 | 5.9100 | 1.77535 | 50.31 | 0.55042 | H-LAK77.NHG | 61.79 |
| 5 | 216.6179 | DD[5] | | | | | 60.81 |
| 6 | 50.6294 | 5.6900 | 1.45650 | 90.27 | 0.53501 | H-FK71.CDGM | 45.00 |
| 7 | 269.2341 | DD[7] | | | | | 44.26 |
| 8 | 122.5961 | 0.6800 | 2.05091 | 26.95 | 0.60473 | H-ZLAF95.NHG | 24.33 |
| 9 | 13.4166 | 5.6700 | | | | | 19.54 |
| 10 | −55.8282 | 4.7100 | 1.98613 | 16.48 | 0.66558 | FDS16-W.HOYA | 19.36 |
| 11 | −16.0295 | 0.6900 | 1.84850 | 43.79 | 0.56197 | J-LASFH22.HIKARI | 19.42 |
| 12 | 34.2529 | 1.7300 | | | | | 18.98 |
| 13 | 26.2480 | 4.5800 | 1.78880 | 28.42 | 0.60066 | J-KZFH10.HIKARI | 19.88 |
| 14 | −48.0709 | 0.6800 | 1.92286 | 20.89 | 0.63806 | H-ZF62.NHG | 19.77 |
| 15 | 163.1017 | DD[15] | | | | | 19.70 |
| 16(St) | ∞ | 2.3300 | | | | | 24.53 |
| 17 | 46.5453 | 7.5000 | 1.84666 | 23.84 | 0.62012 | FDS90-SGP.HOYA | 25.53 |
| 18 | −40.2378 | 1.7600 | 1.78880 | 28.43 | 0.60092 | S-NBH58.OHARA | 25.04 |
| 19 | 40.2378 | 1.3400 | | | | | 24.14 |
| 20 | 101.5821 | 10.0000 | 1.56883 | 56.04 | 0.54853 | BAC4.HOYA | 24.19 |
| 21 | −27.8577 | 1.1000 | 2.00100 | 29.13 | 0.59935 | H-ZLAF82.NHG | 24.50 |
| 22 | −50.5221 | DD[22] | | | | | 25.07 |
| 23 | 76.5245 | 7.3600 | 1.43700 | 95.12 | 0.53487 | H-FK95.NHG | 24.53 |
| 24 | −23.1505 | 0.9000 | 1.91082 | 35.28 | 0.58342 | H-ZLAF4LB.CDGM | 24.19 |
| 25 | −62.1299 | 0.1200 | | | | | 24.85 |
| *26 | 65.9314 | 5.7500 | 1.58313 | 59.46 | 0.54056 | M-BACD12.HOYA | 24.95 |
| *27 | −29.1976 | DD[27] | | | | | 24.80 |
| 28 | −39.6921 | 1.6200 | 1.88300 | 39.22 | 0.57288 | H-ZLAF68N.CDGM | 23.58 |
| 29 | 39.6921 | 8.3500 | 1.59551 | 39.22 | 0.58110 | H-QF14.CDGM | 23.57 |
| 30 | −27.8211 | 7.4660 | | | | | 24.00 |
| 31 | ∞ | 33.0000 | 1.60859 | 46.44 | 0.56664 | BAF52.SCHOTT | 21.04 |
| 32 | ∞ | 13.2000 | 1.51633 | 64.05 | 0.53463 | BK-7.SUMITA | 15.12 |
| 33 | ∞ | 5.4996 | | | | | 12.61 |

TABLE 2
Example 1

| | Object Distance | | | | | |
|---|---|---|---|---|---|---|
| | Infinite | Infinite | Infinite | 0.8 m | 0.8 m | 0.8 m |
| | Changing Magnification State | | | | | |
| | Wide | Middle | Tele | Wide | Middle | Tele |
| Zr | 1.00 | 6.28 | 29.00 | 1.00 | 6.28 | 29.00 |
| f | 8.09 | 50.77 | 234.61 | — | — | — |
| Bf | 42.19 | 42.19 | 42.19 | — | — | — |
| FNo. | 1.97 | 3.10 | 4.04 | 1.97 | 3.12 | 4.32 |
| 2ω[°] | 70.20 | 12.24 | 2.68 | 70.22 | 12.14 | 2.52 |
| DD[5] | 0.9400 | 21.8626 | 26.7132 | 0.9400 | 21.8626 | 26.7132 |
| DD[7] | 0.9400 | 32.6103 | 45.5922 | 0.9400 | 32.6103 | 45.5922 |
| DD[15] | 73.8300 | 21.2371 | 3.4046 | 73.8300 | 21.2371 | 3.4046 |
| DD[22] | 24.1800 | 14.3122 | 24.1956 | 24.1380 | 12.9251 | 5.7747 |
| DD[27] | 1.1700 | 11.0378 | 1.1544 | 1.2120 | 12.4249 | 19.5753 |

TABLE 3
Example 1

| Sn | 26 | 27 |
|---|---|---|
| KA | 5.5694797E+00 | 5.5565132E−02 |
| A3 | 0.0000000E+00 | 0.0000000E+00 |
| A4 | −1.0866877E−05 | −1.3086790E−05 |
| A5 | −4.2869203E−06 | 6.6974012E−06 |
| A6 | 3.9632625E−06 | −1.3762129E−06 |
| A7 | −1.0108913E−06 | 3.2418507E−07 |
| A8 | 7.4301196E−08 | −8.7327646E−08 |
| A9 | 1.2114564E−08 | 1.3207237E−08 |
| A10 | −2.8055179E−09 | −4.6620813E−10 |
| A11 | 1.6056276E−10 | −1.2415493E−10 |
| A12 | 8.4570455E−12 | 1.5994220E−11 |
| A13 | −1.6026379E−12 | −3.7931806E−13 |
| A14 | 8.2197945E−14 | −4.8454014E−14 |
| A15 | −1.6114041E−15 | 3.6046152E−15 |
| A16 | 4.7187187E−18 | −7.4120272E−17 |

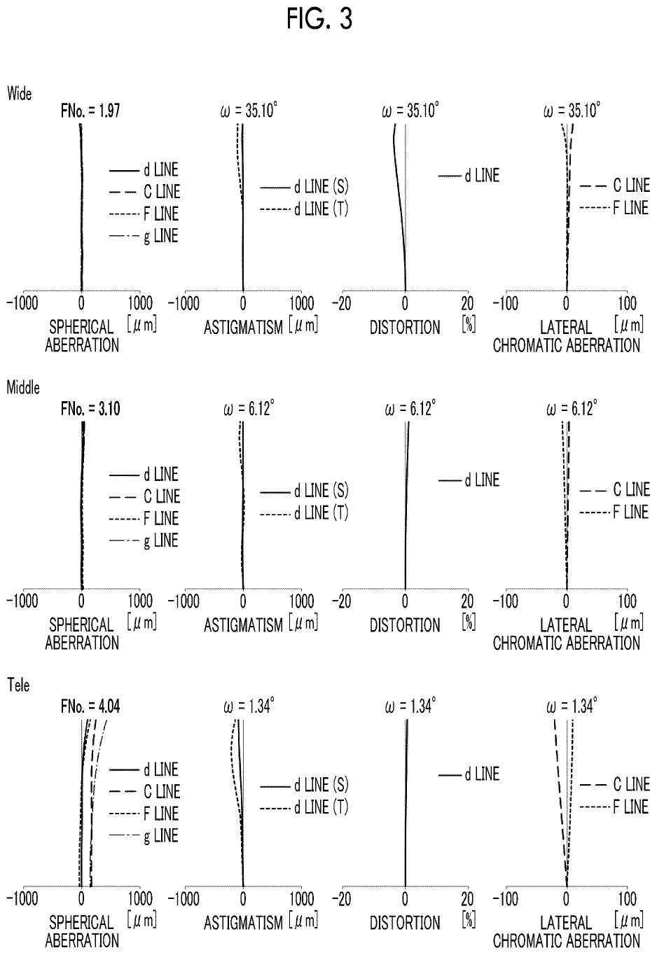

FIG. 3 shows each of aberration diagrams of the zoom lens according to Example 1 in a state where the infinite distance object is in focus. In FIG. 3, the upper part labeled “Wide” shows aberrations in the wide angle end state, the middle part labeled “Middle” shows aberrations in the middle focal length state, and the lower part labeled “Tele” shows aberrations in the telephoto end state. FIG. 3 shows, in order from the left, spherical aberration, astigmatism, distortion, and lateral chromatic aberration. In the spherical aberration diagram, the aberrations at the d line, the C line, the F line, and the g line are indicated by a solid line, a long broken line, a short broken line, and a dot-dashed line, respectively. In the astigmatism diagram, aberration in the sagittal direction with respect to the d line is indicated by a solid line, and aberration in the tangential direction with respect to the d line is indicated by a short broken line. In the distortion diagram, aberration with respect to the d line is indicated by a solid line. In the lateral chromatic aberration diagram, aberrations regarding the C line and the F line are indicated by a long broken line and a short broken line, respectively. In the spherical aberration diagram, the value of the open F-number is shown after FNo.=. In other aberration diagrams, the value of the maximum half angle of view is shown after @=.

Symbols, meanings, description methods, and illustration methods of the respective data pieces according to Example 1 are basically similar to those in the following examples unless otherwise specified. Therefore, hereinafter, repeated description will not be given.

### Example 2

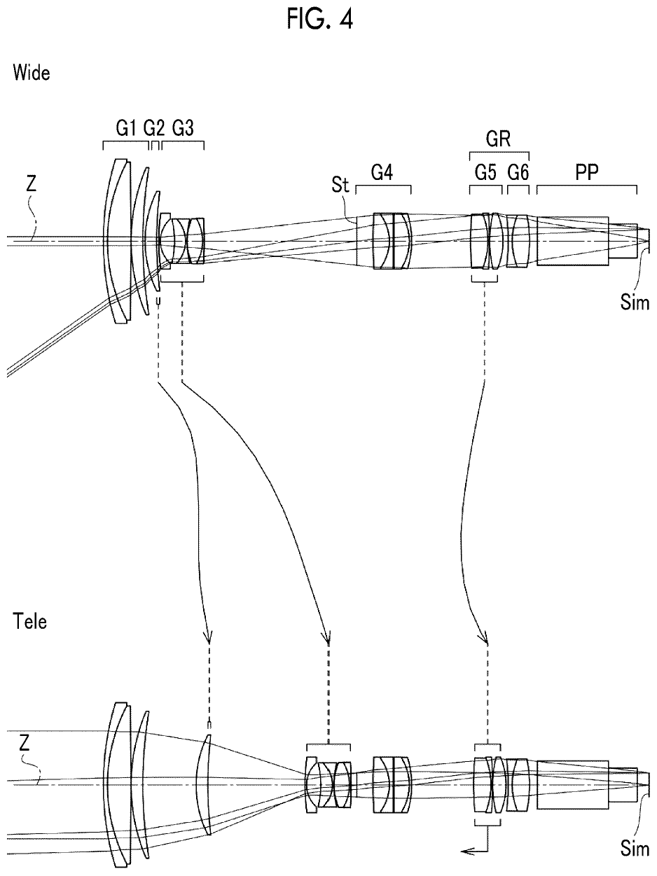

FIG. 4 shows a configuration and movement loci of a zoom lens according to Example 2. The zoom lens according to Example 2 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a negative refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

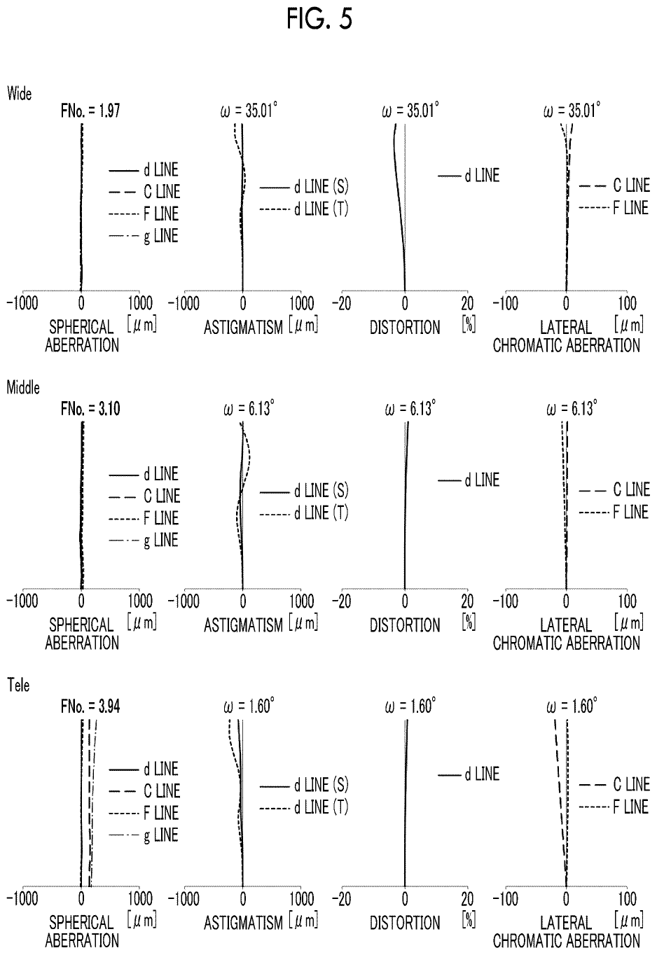

Regarding the zoom lens according to Example 2, Table 4 shows basic lens data, Table 5 shows specifications and variable surface spacings, Table 6 shows aspherical coefficients, and FIG. 5 shows each of the aberration diagrams.

TABLE 4
Example 2

| Sn | R | D | Nd | νd | θgF | Material | ED |
|---|---|---|---|---|---|---|---|
| 1 | 129.5877 | 1.9398 | 2.00069 | 25.47 | 0.61657 | H-ZLAF80.NHG | 65.17 |
| 2 | 78.5583 | 10.8210 | 1.43875 | 94.94 | 0.53433 | S-FPL53.OHARA | 63.53 |
| 3 | −1970.5856 | 0.1200 | | | | | 62.87 |
| 4 | 85.9911 | 5.4455 | 1.77535 | 50.31 | 0.55042 | H-LAK77.NHG | 61.28 |
| 5 | 208.6064 | DD[5] | | | | | 60.34 |
| 6 | 51.2548 | 5.4247 | 1.52841 | 76.45 | 0.53954 | S-FPM4.OHARA | 46.00 |
| 7 | 189.8402 | DD[7] | | | | | 45.22 |
| 8 | 98.6158 | 0.6752 | 2.05090 | 26.94 | 0.60519 | TAFD65.HOYA | 25.50 |
| 9 | 13.3535 | 6.6089 | | | | | 20.23 |
| 10 | −40.6574 | 5.0785 | 1.98613 | 16.48 | 0.66558 | FDS16-W.HOYA | 20.04 |
| 11 | −14.6781 | 0.6848 | 1.84850 | 43.79 | 0.56197 | J-LASFH22.HIKARI | 20.30 |
| 12 | 37.6498 | 0.1201 | | | | | 20.22 |
| 13 | 26.0257 | 7.1716 | 1.78880 | 28.42 | 0.60066 | J-KZFH10.HIKARI | 20.67 |
| 14 | −19.6566 | 0.6999 | 1.92286 | 20.89 | 0.63806 | H-ZF62.NHG | 20.62 |
| 15 | −176.0325 | DD[15] | | | | | 20.83 |
| 16(St) | ∞ | 7.4999 | | | | | 22.09 |
| 17 | 204.7266 | 7.5001 | 1.84666 | 23.84 | 0.62012 | FDS90-SGP.HOYA | 23.84 |
| 18 | −20.3765 | 1.7599 | 1.78880 | 28.42 | 0.60066 | J-KZFH10.HIKARI | 24.06 |
| 19 | ∞ | 0.3852 | | | | | 24.21 |
| 20 | ∞ | 7.0888 | 1.49700 | 81.54 | 0.53748 | S-FPL51.OHARA | 24.22 |
| 21 | −23.3241 | 1.1000 | 1.90366 | 31.31 | 0.59481 | TAFD25.HOYA | 24.34 |
| 22 | −42.3858 | DD[22] | | | | | 25.07 |
| 23 | 147.6175 | 8.0098 | 1.43875 | 94.66 | 0.53402 | S-FPL55.OHARA | 24.70 |
| 24 | −33.6685 | 0.6748 | 1.95375 | 32.32 | 0.59015 | TAFD45.HOYA | 24.46 |
| 25 | −236.8478 | 0.1198 | | | | | 24.91 |
| *26 | 47.5312 | 6.2205 | 1.58313 | 59.38 | 0.54237 | L-BAL42.OHARA | 25.37 |
| *27 | −31.2470 | DD[27] | | | | | 25.37 |
| 28 | −91.6220 | 1.8517 | 1.95375 | 32.32 | 0.59015 | TAFD45.HOYA | 23.83 |
| 29 | 30.4720 | 8.0099 | 1.80610 | 33.27 | 0.58845 | NBFD15-W.HOYA | 23.56 |
| 30 | −58.7348 | 3.6202 | | | | | 23.61 |
| 31 | ∞ | 33.0000 | 1.60859 | 46.44 | 0.56664 | BAF52.SCHOTT | 22.06 |
| 32 | ∞ | 13.2000 | 1.51633 | 64.05 | 0.53463 | BK-7.SUMITA | 15.53 |
| 33 | ∞ | 5.4967 | | | | | 12.76 |

TABLE 5
Example 2

| | Object Distance | | | | | |
|---|---|---|---|---|---|---|
| | Infinite | Infinite | Infinite | 0.8 m | 0.8 m | 0.8 m |
| | Changing Magnification State | | | | | |
| | Wide | Middle | Tele | Wide | Middle | Tele |
| Zr | 1.00 | 6.28 | 24.20 | 1.00 | 6.28 | 24.20 |
| f | 8.08 | 50.73 | 195.63 | — | — | — |
| Bf | 38.34 | 38.34 | 38.34 | — | — | — |
| FNo. | 1.97 | 3.10 | 3.94 | 1.97 | 3.13 | 3.98 |
| 2ω[°] | 70.02 | 12.26 | 3.20 | 70.04 | 12.16 | 3.18 |
| DD[5] | 1.0037 | 19.6949 | 24.6239 | 1.0037 | 19.6949 | 24.6239 |
| DD[7] | 0.9384 | 33.4980 | 45.0314 | 0.9384 | 33.4980 | 45.0314 |
| DD[15] | 70.3975 | 19.1466 | 2.6843 | 70.3975 | 19.1466 | 2.6843 |
| DD[22] | 27.2987 | 16.4115 | 28.7223 | 27.2334 | 14.3505 | 9.0226 |
| DD[27] | 2.4130 | 13.3002 | 0.9894 | 2.4783 | 15.3612 | 20.6891 |

TABLE 6
Example 2

| Sn | 26 | 27 |
|---|---|---|
| KA | −4.6910448E−01 | 6.7368518E−01 |
| A3 | 0.0000000E+00 | 0.0000000E+00 |
| A4 | −6.3764095E−05 | −6.1009003E−05 |
| A5 | 3.8356765E−05 | 5.4491901E−05 |
| A6 | −8.3052310E−06 | −2.5929890E−05 |
| A7 | −1.6234303E−06 | 7.9990490E−06 |
| A8 | 1.4002016E−06 | −1.6764536E−06 |
| A9 | −3.6773090E−07 | 2.4829841E−07 |
| A10 | 5.1880985E−08 | −2.6043569E−08 |
| A11 | −4.0584407E−09 | 1.7423358E−09 |
| A12 | 1.2904829E−10 | −3.7620592E−11 |
| A13 | 5.2109625E−12 | −5.1866047E−12 |
| A14 | −6.6402691E−13 | 5.5077526E−13 |
| A15 | 2.4665719E−14 | −2.2406205E−14 |
| A16 | −3.3803094E−16 | 3.4969408E−16 |

### Example 3

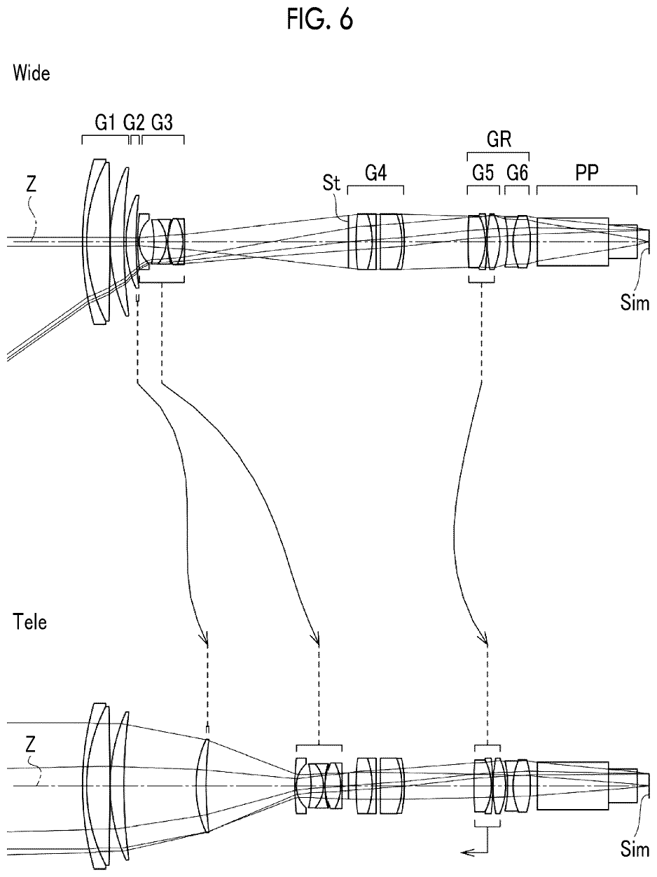

FIG. 6 shows a configuration and movement loci of a zoom lens according to Example 3. The zoom lens according to Example 3 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a positive refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

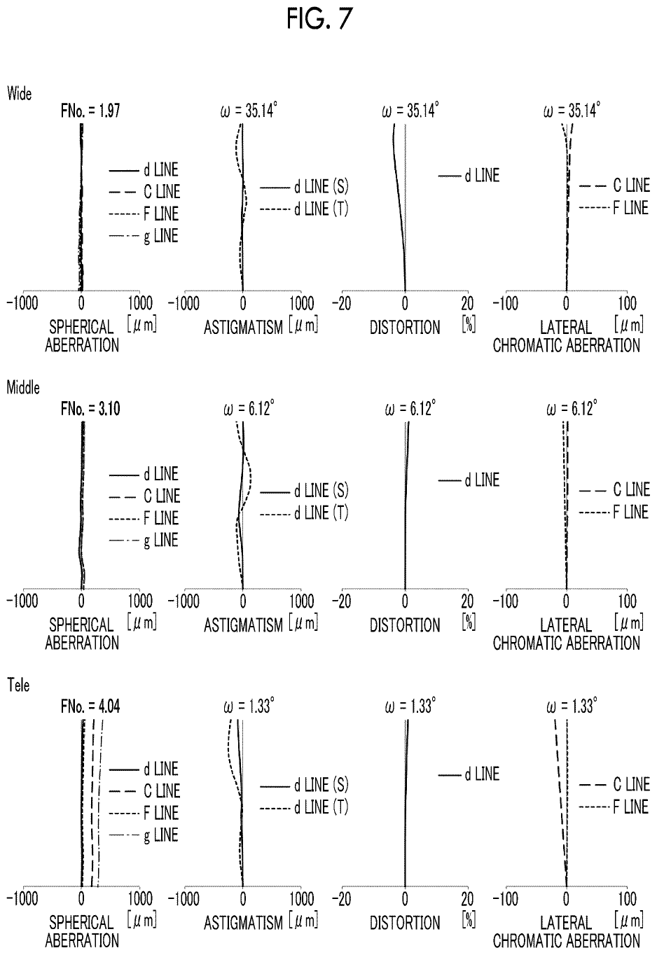

Regarding the zoom lens according to Example 3, Table 7 shows basic lens data, Table 8 shows specifications and variable surface spacings, Table 9 shows aspherical coefficients, and FIG. 7 shows each of the aberration diagrams.

TABLE 7
Example 3

| Sn | R | D | Nd | νd | θgF | Material | ED |
|---|---|---|---|---|---|---|---|
| 1 | 138.3424 | 1.9398 | 2.05090 | 26.94 | 0.60519 | TAFD65.HOYA | 64.70 |
| 2 | 80.0636 | 10.7831 | 1.43875 | 94.94 | 0.53433 | S-FPL53.OHARA | 63.10 |
| 3 | −1588.2010 | 0.1200 | | | | | 62.53 |
| 4 | 83.0829 | 6.3571 | 1.75500 | 52.32 | 0.54757 | S-LAH97.OHARA | 61.13 |
| 5 | 256.9112 | DD[5] | | | | | 60.07 |
| 6 | 51.0298 | 4.6224 | 1.57144 | 71.61 | 0.54193 | FCD615.HOYA | 42.76 |
| 7 | 167.2261 | DD[7] | | | | | 42.04 |
| 8 | 106.4374 | 0.6748 | 2.05090 | 26.94 | 0.60519 | TAFD65.HOYA | 25.50 |
| 9 | 13.5030 | 6.8919 | | | | | 20.29 |
| 10 | −45.0967 | 5.6826 | 1.98613 | 16.48 | 0.66558 | FDS16-W.HOYA | 19.98 |
| 11 | −15.2518 | 0.6848 | 1.84850 | 43.79 | 0.56197 | J-LASFH22.HIKARI | 20.26 |
| 12 | 36.5342 | 0.1198 | | | | | 20.40 |
| 13 | 25.5336 | 6.9187 | 1.78880 | 28.42 | 0.60066 | J-KZFH10.HIKARI | 20.97 |
| 14 | −21.8217 | 0.6998 | 1.92286 | 20.89 | 0.63806 | H-ZF62.NHG | 20.80 |
| 15 | −548.2435 | DD[15] | | | | | 20.92 |
| 16(St) | ∞ | 3.4548 | | | | | 24.09 |
| 17 | 106.0299 | 7.5001 | 1.84666 | 23.84 | 0.62012 | FDS90-SGP.HOYA | 25.05 |
| 18 | −37.9667 | 1.7602 | 1.78880 | 28.42 | 0.60066 | J-KZFH10.HIKARI | 25.11 |
| 19 | ∞ | 1.9966 | | | | | 25.07 |
| 20 | ∞ | 10.0102 | 1.49700 | 81.61 | 0.53887 | FCD1.HOYA | 25.04 |
| 21 | −34.1934 | 1.1001 | 1.90200 | 25.26 | 0.61662 | J- | 24.95 |
| | | | | | | LASFH24HS.HIKARI | |
| 22 | −64.7479 | DD[22] | | | | | 25.30 |
| 23 | 191.6202 | 8.0102 | 1.43875 | 94.66 | 0.53402 | S-FPL55.OHARA | 23.86 |
| 24 | −25.7910 | 0.6755 | 1.90043 | 37.37 | 0.57668 | TAFD37A.HOYA | 23.56 |
| 25 | −114.6268 | 0.1198 | | | | | 24.13 |
| *26 | 55.2830 | 5.8436 | 1.58313 | 59.38 | 0.54237 | L-BAL42.OHARA | 24.50 |
| *27 | −30.3133 | DD[27] | | | | | 24.53 |
| 28 | −53.6893 | 2.5000 | 1.95203 | 26.20 | 0.61011 | NBFD265.HOYA | 22.81 |
| 29 | 28.9322 | 8.0102 | 1.85000 | 27.03 | 0.60935 | J-LASFH23.HIKARI | 23.07 |
| 30 | −43.1609 | 3.2037 | | | | | 23.44 |
| 31 | ∞ | 33.0000 | 1.60859 | 46.44 | 0.56664 | BAF52.SCHOTT | 21.92 |
| 32 | ∞ | 13.2000 | 1.51633 | 64.05 | 0.53463 | BK-7.SUMITA | 15.48 |
| 33 | ∞ | 5.5064 | | | | | 12.75 |

TABLE 8
Example 3

| | Object Distance | | | | | |
|---|---|---|---|---|---|---|
| | Infinite | Infinite | Infinite | 0.8 m | 0.8 m | 1.2 m |
| | Changing Magnification State | | | | | |
| | Wide | Middle | Tele | Wide | Middle | Tele |
| Zr | 1.00 | 6.28 | 29.00 | 1.00 | 6.28 | 29.00 |
| f | 8.09 | 50.76 | 234.56 | — | — | — |
| Bf | 37.93 | 37.93 | 37.93 | — | — | — |
| FNo. | 1.97 | 3.10 | 4.04 | 1.97 | 3.13 | 4.01 |
| 2ω[°] | 70.28 | 12.24 | 2.66 | 70.32 | 12.12 | 2.70 |
| DD[5] | 0.9406 | 24.0604 | 33.3602 | 0.9406 | 24.0604 | 33.3602 |
| DD[7] | 0.8106 | 30.4800 | 41.1367 | 0.8106 | 30.4800 | 41.1367 |
| DD[15] | 75.6933 | 22.9041 | 2.9476 | 75.6933 | 22.9041 | 2.9476 |
| DD[22] | 29.4992 | 16.7536 | 32.2438 | 29.4328 | 14.6560 | 11.1192 |
| DD[27] | 3.7132 | 16.4588 | 0.9686 | 3.7796 | 18.5564 | 22.0932 |

TABLE 9
Example 3

| Sn | 26 | 27 |
|---|---|---|
| KA | 2.1222863E+00 | 8.1399476E−01 |
| A3 | 0.0000000E+00 | 0.0000000E+00 |
| A4 | −4.6657661E−05 | −1.0104049E−05 |
| A5 | 1.7491730E−05 | −2.3070713E−05 |
| A6 | −4.2732732E−06 | 1.9402934E−05 |
| A7 | 9.2460348E−07 | −6.0474300E−06 |
| A8 | −1.5547152E−07 | 8.8621323E−07 |
| A9 | 1.4646582E−08 | −3.2883492E−08 |
| A10 | −4.9287559E−10 | −7.7692167E−09 |
| A11 | 6.8248070E−12 | 8.3066794E−10 |
| A12 | −6.8591585E−12 | 6.3344622E−11 |
| A13 | 1.0770487E−12 | −1.8267581E−11 |
| A14 | −7.0841394E−14 | 1.5102645E−12 |
| A15 | 2.3194998E−15 | −5.8218329E−14 |
| A16 | −3.2791290E−17 | 8.9163452E−16 |

### Example 4

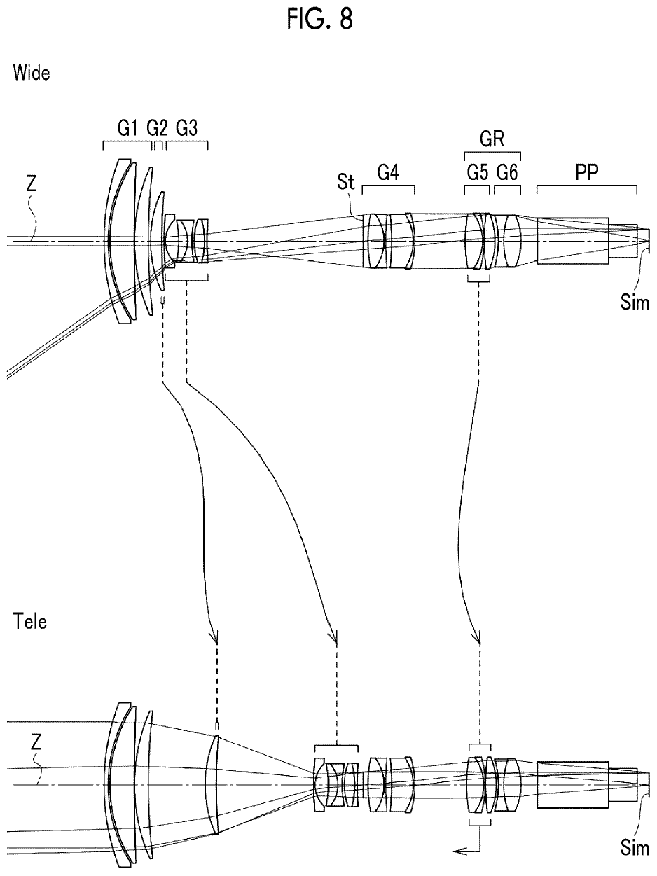

FIG. 8 shows a configuration and movement loci of a zoom lens according to Example 4. The zoom lens according to Example 4 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a negative refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

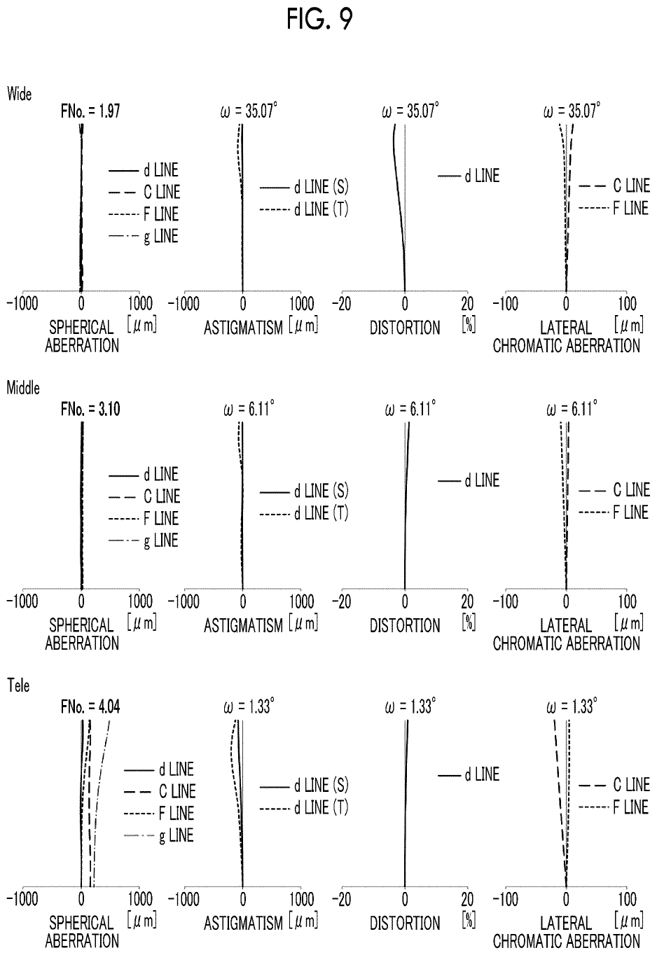

Regarding the zoom lens according to Example 4, Table 10 shows basic lens data, Table 11 shows specifications and variable surface spacings, Table 12 shows aspherical coefficients, and FIG. 9 shows each of the aberration diagrams.

TABLE 10
Example 4

| Sn | R | D | Nd | νd | θgF | Material | ED |
|---|---|---|---|---|---|---|---|
| 1 | 106.8037 | 1.9400 | 2.05090 | 26.94 | 0.60519 | TAFD65.HOYA | 65.33 |
| 2 | 67.4498 | 0.8193 | | | | | 63.31 |
| 3 | 67.1316 | 11.2244 | 1.43700 | 95.12 | 0.53487 | H-FK95.NHG | 63.50 |
| 4 | 744.1174 | 0.1200 | | | | | 62.80 |
| 5 | 84.4056 | 6.4270 | 1.76385 | 48.49 | 0.55898 | S-LAH96.OHARA | 61.63 |
| 6 | 282.7205 | DD[6] | | | | | 60.61 |
| 7 | 54.7300 | 5.1501 | 1.49782 | 82.57 | 0.53862 | J-FKH1.HIKARI | 45.27 |
| 8 | 233.2971 | DD[8] | | | | | 44.53 |
| 9 | 118.5519 | 0.6750 | 2.05090 | 26.94 | 0.60519 | TAFD65.HOYA | 24.36 |
| 10 | 13.4050 | 6.1165 | | | | | 19.55 |
| 11 | −46.9941 | 4.1478 | 1.98613 | 16.48 | 0.66558 | FDS16-W.HOYA | 19.28 |
| 12 | −15.1851 | 2.0090 | 1.88300 | 39.22 | 0.57288 | H-ZLAF68N.CDGM | 19.38 |
| 13 | 50.6806 | 1.0023 | | | | | 19.20 |
| 14 | 28.7190 | 4.8535 | 1.83400 | 37.16 | 0.57759 | S-LAH60.OHARA | 19.95 |
| 15 | −37.2520 | 1.1642 | 1.91082 | 35.25 | 0.58335 | TAFD35L.HOYA | 19.83 |
| 16 | 138.0243 | DD[16] | | | | | 19.69 |
| 17(St) | ∞ | 2.2352 | | | | | 23.95 |
| 18 | 62.3439 | 7.5000 | 1.84666 | 23.84 | 0.62012 | FDS90-SGP.HOYA | 24.73 |
| 19 | −20.2417 | 0.7305 | 1.80000 | 29.84 | 0.60178 | S-NBH55.OHARA | 24.61 |
| 20 | 123.8058 | 2.7363 | | | | | 24.06 |
| 21 | −106.1203 | 10.0100 | 1.56883 | 56.04 | 0.54853 | BAC4.HOYA | 24.02 |
| 22 | −21.6557 | 0.7000 | 1.92286 | 20.89 | 0.63806 | H-ZF62.NHG | 24.48 |
| 23 | −42.0713 | DD[23] | | | | | 25.24 |
| 24 | 66.6302 | 8.0100 | 1.43700 | 95.10 | 0.53364 | FCD100.HOYA | 25.10 |
| 25 | −20.9978 | 0.6750 | 1.88300 | 40.76 | 0.56679 | S-LAH58.OHARA | 24.77 |
| 26 | −46.6157 | 0.1200 | | | | | 25.50 |
| *27 | 87.0593 | 5.0006 | 1.58313 | 59.38 | 0.54237 | L-BAL42.OHARA | 25.42 |
| *28 | −32.0262 | DD[28] | | | | | 25.29 |
| 29 | −42.3216 | 2.4999 | 1.88300 | 40.76 | 0.56679 | S-LAH58.OHARA | 23.79 |
| 30 | 35.5497 | 8.0000 | 1.58144 | 40.75 | 0.57757 | S-TIL25.OHARA | 23.65 |
| 31 | −27.5353 | 7.5552 | | | | | 24.00 |
| 32 | ∞ | 33.0000 | 1.60859 | 46.44 | 0.56664 | BAF52.SCHOTT | 21.02 |
| 33 | ∞ | 13.2000 | 1.51633 | 64.05 | 0.53463 | BK-7.SUMITA | 15.12 |
| 34 | ∞ | 5.5094 | | | | | 12.62 |

TABLE 11
Example 4

| | Object Distance | | | | | |
|---|---|---|---|---|---|---|
| | Infinite | Infinite | Infinite | 0.8 m | 0.8 m | 0.8 m |
| | Changing Magnification State | | | | | |
| | Wide | Middle | Tele | Wide | Middle | Tele |
| Zr | 1.00 | 6.28 | 29.00 | 1.00 | 6.28 | 29.00 |
| f | 8.08 | 50.74 | 234.46 | — | — | — |
| Bf | 42.28 | 42.28 | 42.28 | — | — | — |
| FNo. | 1.97 | 3.10 | 4.04 | 1.98 | 3.12 | 4.31 |
| 2ω[°] | 70.14 | 12.22 | 2.66 | 70.16 | 12.12 | 2.52 |
| DD[6] | 1.0466 | 20.1282 | 26.2657 | 1.0466 | 20.1282 | 26.2657 |
| DD[8] | 1.0403 | 32.9114 | 45.1005 | 1.0403 | 32.9114 | 45.1005 |
| DD[16] | 71.9813 | 21.0286 | 2.7021 | 71.9813 | 21.0286 | 2.7021 |
| DD[23] | 23.3616 | 14.2407 | 23.9262 | 23.3205 | 12.8759 | 5.6637 |
| DD[28] | 1.5115 | 10.6324 | 0.9469 | 1.5526 | 11.9972 | 19.2094 |

TABLE 12
Example 4

| Sn | 27 | 28 |
|---|---|---|
| KA | 1.9879723E+00 | 8.4135349E−01 |
| A3 | 0.0000000E+00 | 0.0000000E+00 |
| A4 | −2.4807503E−05 | −1.5647384E−05 |
| A5 | 7.7027650E−06 | 2.2034100E−06 |
| A6 | 8.6404259E−08 | 3.7594696E−06 |
| A7 | −5.7905614E−07 | −1.7139198E−06 |
| A8 | 1.3489480E−07 | 2.9380615E−07 |
| A9 | −1.4662438E−08 | −1.5397499E−08 |
| A10 | 1.0595216E−09 | −1.7698263E−09 |
| A11 | −7.0084218E−11 | 2.6112413E−10 |
| A12 | −1.8575631E−12 | −2.7210898E−12 |
| A13 | 1.4901262E−12 | −1.3764142E−12 |
| A14 | −1.7217745E−13 | 9.3841291E−14 |
| A15 | 8.4561018E−15 | −1.9901402E−15 |
| A16 | −1.5686235E−16 | 1.9679110E−18 |

### Example 5

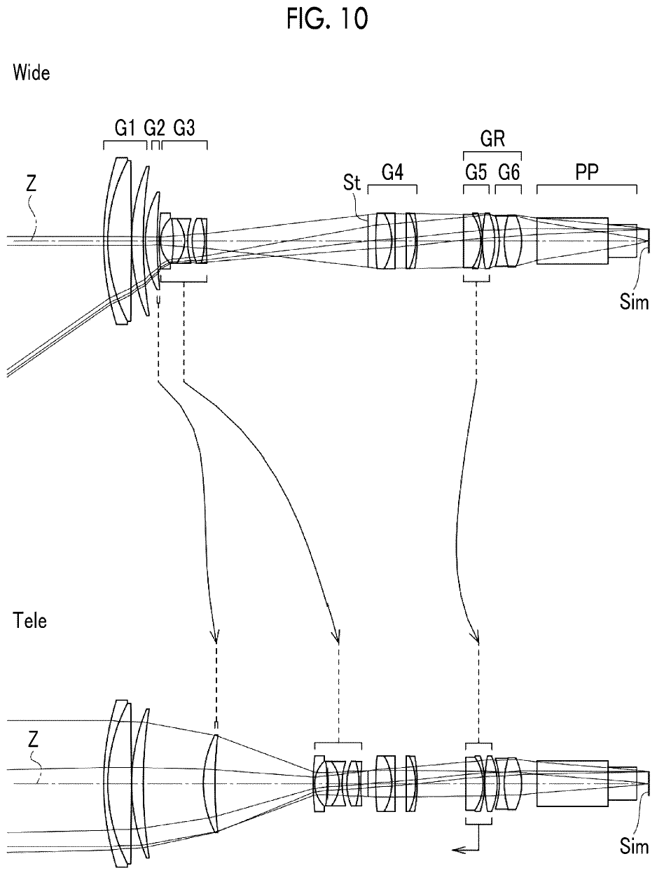

FIG. 10 shows a configuration and movement loci of a zoom lens according to Example 5. The zoom lens according to Example 5 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a negative refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

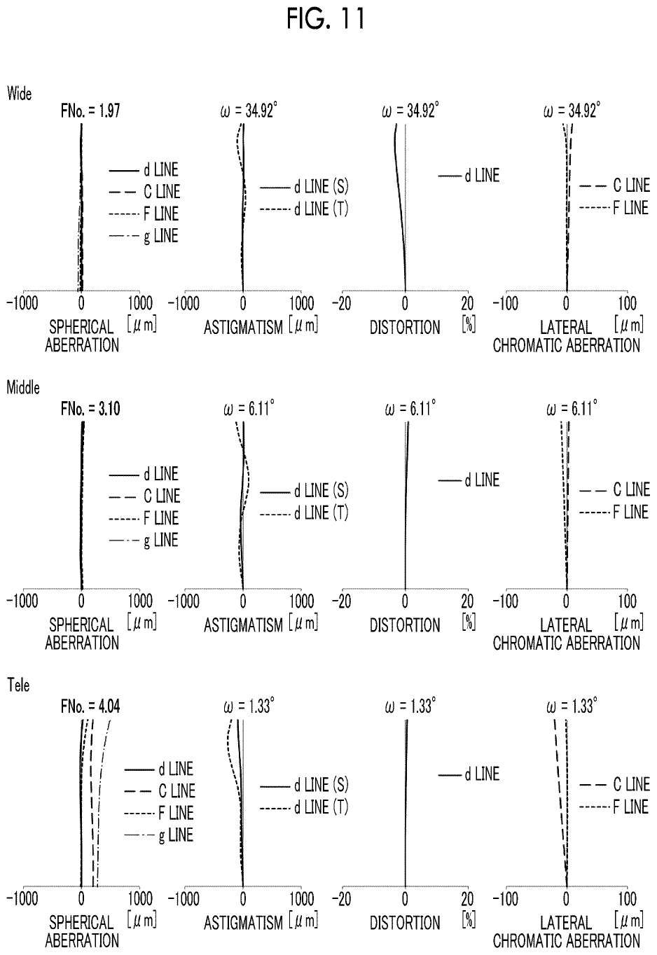

Regarding the zoom lens according to Example 5, Table 13 shows basic lens data, Table 14 shows specifications and variable surface spacings, Table 15 shows aspherical coefficients, and FIG. 11 shows each of the aberration diagrams.

TABLE 13
Example 5

| Sn | R | D | Nd | νd | θgF | Material | ED |
|---|---|---|---|---|---|---|---|
| 1 | 127.0678 | 1.9402 | 2.00069 | 25.47 | 0.61657 | H-ZLAF80.NHG | 66.60 |
| 2 | 79.7287 | 10.9341 | 1.43875 | 94.94 | 0.53433 | S-FPL53.OHARA | 64.94 |
| 3 | −2241.8436 | 0.1200 | | | | | 64.24 |
| 4 | 88.6943 | 5.3680 | 1.77535 | 50.31 | 0.55042 | H-LAK77.NHG | 62.54 |
| 5 | 214.0753 | DD[5] | | | | | 61.63 |
| 6 | 49.8074 | 5.4063 | 1.48071 | 85.29 | 0.53623 | FCD915.HOYA | 45.08 |
| 7 | 199.5118 | DD[7] | | | | | 44.36 |
| 8 | 114.3619 | 0.6748 | 2.05090 | 26.94 | 0.60519 | TAFD65.HOYA | 25.74 |
| 9 | 14.1824 | 5.8690 | | | | | 20.70 |
| 10 | −68.9172 | 5.2624 | 1.98613 | 16.48 | 0.66558 | FDS16-W.HOYA | 20.49 |
| 11 | −15.9903 | 1.3149 | 1.84850 | 43.79 | 0.56197 | J-LASFH22.HIKARI | 20.46 |
| 12 | 31.3820 | 2.1825 | | | | | 19.52 |
| 13 | 26.6371 | 5.7179 | 1.78880 | 28.42 | 0.60066 | J-KZFH10.HIKARI | 20.59 |
| 14 | −34.1536 | 0.8512 | 1.92286 | 20.89 | 0.63806 | H-ZF62.NHG | 20.39 |
| 15 | 154.5589 | DD[15] | | | | | 20.26 |
| 16(St) | ∞ | 3.4691 | | | | | 24.14 |
| 17 | 117.3229 | 7.4903 | 1.84666 | 23.84 | 0.62012 | FDS90-SGP.HOYA | 25.05 |
| 18 | −24.6501 | 1.5501 | 1.78880 | 28.42 | 0.60066 | J-KZFH10.HIKARI | 25.13 |
| 19 | ∞ | 5.1636 | | | | | 25.07 |
| 20 | ∞ | 4.3007 | 1.59349 | 67.00 | 0.53667 | PCD51.HOYA | 24.96 |
| 21 | −29.1795 | 0.6998 | 1.90110 | 27.06 | 0.60718 | NBFD27.HOYA | 24.94 |
| 22 | −74.6302 | DD[22] | | | | | 25.28 |
| 23 | −2318.9140 | 8.0098 | 1.43700 | 95.10 | 0.53364 | FCD100.HOYA | 24.29 |
| 24 | −21.4075 | 0.6748 | 1.95375 | 32.32 | 0.59015 | TAFD45.HOYA | 24.17 |
| 25 | −41.3165 | 0.1198 | | | | | 24.98 |
| *26 | 58.7633 | 5.7415 | 1.58313 | 59.38 | 0.54237 | L-BAL42.OHARA | 25.13 |
| *27 | −31.1349 | DD[27] | | | | | 24.97 |
| 28 | −37.5939 | 2.3594 | 1.88300 | 39.22 | 0.57288 | H-ZLAF68N.CDGM | 23.33 |
| 29 | 39.7903 | 8.0102 | 1.60342 | 38.03 | 0.58356 | S-TIM5.OHARA | 23.43 |
| 30 | −26.9730 | 7.0742 | | | | | 23.89 |
| 31 | ∞ | 33.0000 | 1.60859 | 46.44 | 0.56664 | BAF52.SCHOTT | 21.03 |
| 32 | ∞ | 13.2000 | 1.51633 | 64.05 | 0.53463 | BK-7.SUMITA | 15.11 |
| 33 | ∞ | 5.5081 | | | | | 12.59 |

TABLE 14
Example 5

| | Object Distance | | | | | |
|---|---|---|---|---|---|---|
| | Infinite | Infinite | Infinite | 0.8 m | 0.8 m | 0.8 m |
| | Changing Magnification State | | | | | |
| | Wide | Middle | Tele | Wide | Middle | Tele |
| Zr | 1.00 | 6.28 | 29.00 | 1.00 | 6.28 | 29.00 |
| f | 8.11 | 50.88 | 235.10 | — | — | — |
| Bf | 41.80 | 41.80 | 41.80 | — | — | — |
| FNo. | 1.97 | 3.10 | 4.04 | 1.98 | 3.12 | 4.11 |
| 2ω[°] | 69.84 | 12.22 | 2.66 | 69.86 | 12.16 | 2.64 |
| DD[5] | 1.0135 | 22.8153 | 27.8803 | 1.0135 | 22.8153 | 27.8803 |
| DD[7] | 0.9596 | 32.6826 | 45.5164 | 0.9596 | 32.6826 | 45.5164 |
| DD[15] | 74.7501 | 21.2253 | 3.3265 | 74.7501 | 21.2253 | 3.3265 |
| DD[22] | 21.5032 | 12.5150 | 22.6043 | 21.4607 | 11.1692 | 5.5808 |
| DD[27] | 2.0560 | 11.0442 | 0.9549 | 2.0985 | 12.3900 | 17.9784 |

TABLE 15
Example 5

| Sn | 26 | 27 |
|---|---|---|
| KA | 3.4073562E+00 | 5.6125731E−01 |
| A3 | 0.0000000E+00 | 0.0000000E+00 |
| A4 | −4.8952689E−05 | −4.0688582E−05 |
| A5 | 2.1850017E−05 | 1.4801256E−05 |
| A6 | −7.5152690E−06 | −6.8370622E−07 |
| A7 | 2.7835666E−06 | −6.8369532E−08 |
| A8 | −7.8200718E−07 | −1.0977027E−07 |
| A9 | 1.3314166E−07 | 3.2559185E−08 |
| A10 | −1.3304971E−08 | −2.2921251E−09 |
| A11 | 8.8175124E−10 | −2.5158622E−10 |
| A12 | −7.1995780E−11 | 5.0234624E−11 |
| A13 | 8.3303938E−12 | −2.6220943E−12 |
| A14 | −6.6175971E−13 | −1.3573141E−14 |
| A15 | 2.7190547E−14 | 5.5433537E−15 |
| A16 | −4.4669965E−16 | −1.3838032E−16 |

### Example 6

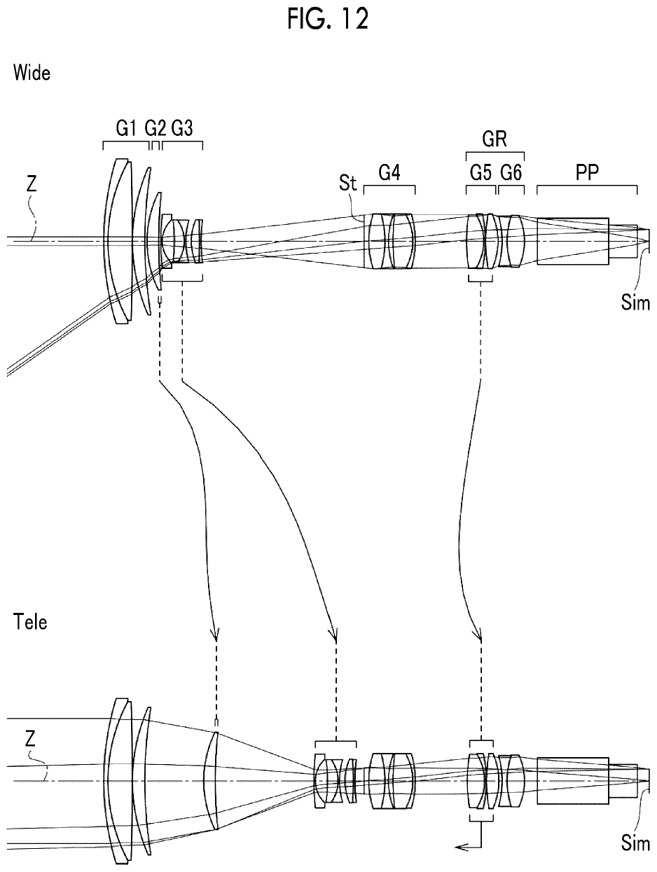

FIG. 12 shows a configuration and movement loci of a zoom lens according to Example 6. The zoom lens according to Example 6 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a negative refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

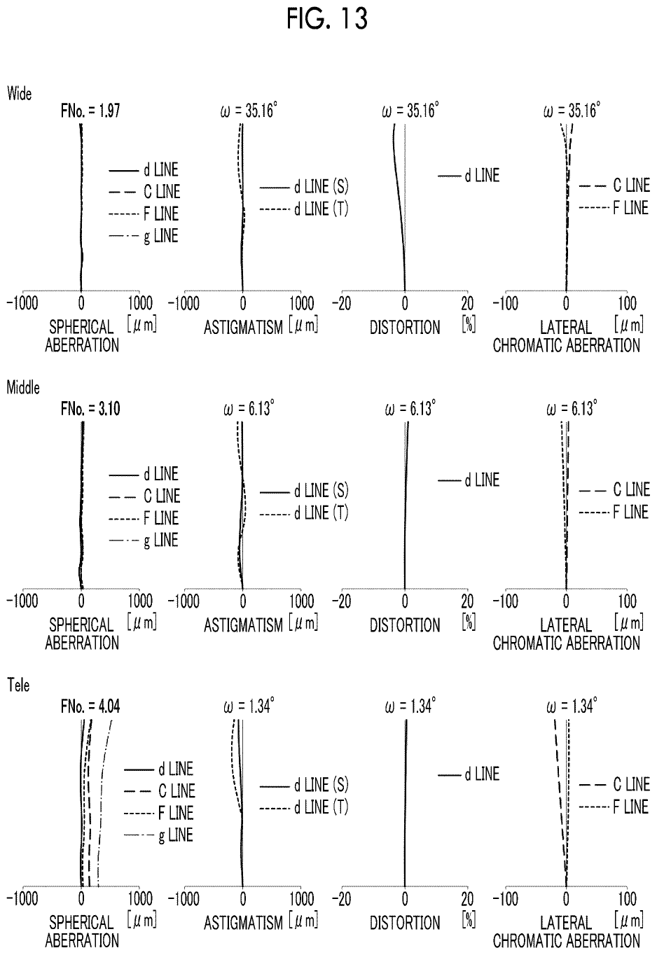

Regarding the zoom lens according to Example 6, Table 16 shows basic lens data, Table 17 shows specifications and variable surface spacings, Table 18 shows aspherical coefficients, and FIG. 13 shows each of the aberration diagrams.

TABLE 16
Example 6

| Sn | R | D | Nd | νd | θgF | Material | ED |
|---|---|---|---|---|---|---|---|
| 1 | 129.9475 | 1.9500 | 2.05091 | 26.95 | 0.60473 | H-ZLAF95.NHG | 66.20 |
| 2 | 78.2296 | 11.2626 | 1.43700 | 95.10 | 0.53364 | FCD100.HOYA | 64.48 |
| 3 | −1217.7441 | 0.1200 | | | | | 63.87 |
| 4 | 84.3116 | 5.7069 | 1.77535 | 50.31 | 0.55042 | H-LAK77.NHG | 62.25 |
| 5 | 210.9936 | DD[5] | | | | | 61.29 |
| 6 | 51.5428 | 5.3875 | 1.49782 | 82.57 | 0.53862 | J-FKH1.HIKARI | 45.22 |
| 7 | 216.9787 | DD[7] | | | | | 44.48 |
| 8 | 118.1088 | 0.6748 | 2.05091 | 26.95 | 0.60473 | H-ZLAF95.NHG | 24.94 |
| 9 | 13.7828 | 5.6037 | | | | | 20.05 |
| 10 | −72.8990 | 4.6156 | 1.98613 | 16.48 | 0.66558 | FDS16-W.HOYA | 19.86 |
| 11 | −17.3033 | 0.6956 | 1.84850 | 43.79 | 0.56197 | J-LASFH22.HIKARI | 19.81 |
| 12 | 34.7657 | 2.5615 | | | | | 19.14 |
| 13 | 25.8286 | 3.8044 | 1.78880 | 28.42 | 0.60066 | J-KZFH10.HIKARI | 20.09 |
| 14 | −169.8883 | 0.7436 | 1.92286 | 20.89 | 0.63806 | H-ZF62.NHG | 19.90 |
| 15 | 73.6946 | DD[15] | | | | | 19.71 |
| 16(St) | ∞ | 2.1390 | | | | | 24.45 |
| 17 | 40.8862 | 7.4983 | 1.84666 | 23.84 | 0.62012 | FDS90-SGP.HOYA | 25.42 |
| 18 | −46.8970 | 1.6328 | 1.78880 | 28.42 | 0.60066 | J-KZFH10.HIKARI | 24.76 |
| 19 | 35.3805 | 2.1112 | | | | | 23.71 |
| 20 | 113.7377 | 9.2050 | 1.51742 | 52.43 | 0.55649 | S-NSL36.OHARA | 23.86 |
| 21 | −25.1151 | 1.0998 | 1.90110 | 27.06 | 0.60718 | NBFD27.HOYA | 24.21 |
| 22 | −44.9433 | DD[22] | | | | | 24.86 |
| 23 | 74.9250 | 8.0103 | 1.43700 | 95.10 | 0.53364 | FCD100.HOYA | 24.69 |
| 24 | −23.2290 | 0.6813 | 1.91082 | 35.25 | 0.58224 | TAFD35.HOYA | 24.32 |
| 25 | −61.5616 | 0.1198 | | | | | 24.94 |
| *26 | 64.9755 | 5.7545 | 1.58660 | 59.01 | 0.54152 | K- | 25.06 |
| | | | | | | SKLD200.SUMITA | |
| *27 | −29.6428 | DD[27] | | | | | 24.91 |
| 28 | −43.9952 | 2.3375 | 1.88300 | 40.76 | 0.56679 | S-LAH58.OHARA | 23.44 |
| 29 | 37.7440 | 8.0100 | 1.58144 | 40.89 | 0.57737 | H-QF50.CDGM | 23.49 |
| 30 | −28.9580 | 6.0025 | | | | | 24.00 |
| 31 | ∞ | 33.0000 | 1.60859 | 46.44 | 0.56664 | BAF52.SCHOTT | 21.41 |
| 32 | ∞ | 13.2000 | 1.51633 | 64.05 | 0.53463 | BK-7.SUMITA | 15.28 |
| 33 | ∞ | 5.4992 | | | | | 12.68 |

TABLE 17
Example 6

| | Object Distance | | | | | |
|---|---|---|---|---|---|---|
| | Infinite | Infinite | Infinite | 0.8 m | 0.8 m | 0.8 m |
| | Changing Magnification State | | | | | |
| | Wide | Middle | Tele | Wide | Middle | Tele |
| Zr | 1.00 | 6.28 | 29.00 | 1.00 | 6.28 | 29.00 |
| f | 8.08 | 50.69 | 234.21 | — | — | — |
| Bf | 40.72 | 40.72 | 40.72 | — | — | — |
| FNo. | 1.97 | 3.10 | 4.04 | 1.97 | 3.13 | 4.28 |
| 2ω[°] | 70.32 | 12.26 | 2.68 | 70.54 | 12.18 | 2.54 |
| DD[5] | 1.0087 | 22.4172 | 27.2416 | 1.0087 | 22.4172 | 27.2416 |
| DD[7] | 0.9544 | 32.6246 | 45.6076 | 0.9544 | 32.6246 | 45.6076 |
| DD[15] | 75.1672 | 22.0885 | 4.2811 | 75.1672 | 22.0885 | 4.2811 |
| DD[22] | 23.7385 | 14.1235 | 24.1242 | 23.6966 | 12.7359 | 6.0800 |
| DD[27] | 1.8843 | 11.4993 | 1.4986 | 1.9262 | 12.8869 | 19.5428 |

TABLE 18
Example 6

| Sn | 26 | 27 |
|---|---|---|
| KA | 5.3104122E+00 | 8.9992703E−02 |
| A3 | 0.0000000E+00 | 0.0000000E+00 |
| A4 | −8.6037722E−06 | −3.5590881E−05 |
| A5 | −3.3362195E−05 | 1.0645737E−05 |
| A6 | 2.4973149E−05 | 2.7307806E−07 |
| A7 | −7.8640344E−06 | −2.2137082E−07 |
| A8 | 1.3270964E−06 | −6.2826295E−08 |
| A9 | −1.2182529E−07 | 2.1809955E−08 |
| A10 | 5.0025978E−09 | −1.5961560E−09 |
| A11 | −2.0711476E−11 | −8.8525449E−11 |
| A12 | 1.1176259E−11 | 1.0259388E−11 |
| A13 | −2.7081062E−12 | 1.3310137E−12 |
| A14 | 1.9546447E−13 | −2.2511192E−13 |
| A15 | −6.1857473E−15 | 1.1580911E−14 |
| A16 | 7.3622748E−17 | −2.1083179E−16 |

### Example 7

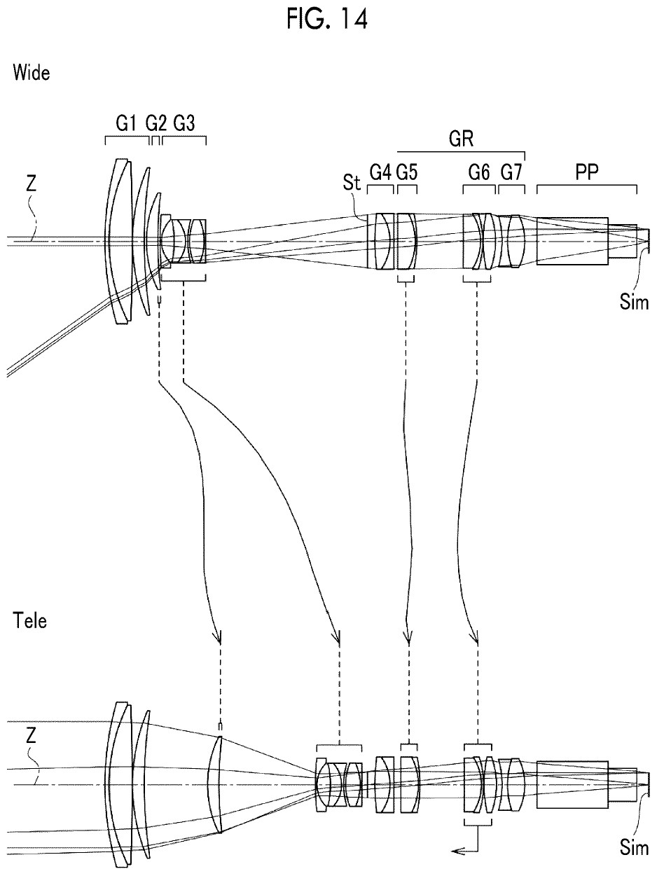

FIG. 14 shows a configuration and movement loci of a zoom lens according to Example 7. The zoom lens according to Example 7 consists of a first lens group G1 having a positive refractive power, a second lens group G2 having a positive refractive power, a third lens group G3 having a negative refractive power, a fourth lens group G4 having a positive refractive power, a fifth lens group G5 having a negative refractive power, a sixth lens group G6 having a positive refractive power, and a seventh lens group G7 having a negative refractive power in order from the object side to the image side. The subsequent group GR consists of the fifth lens group G5, the sixth lens group G6, and the seventh lens group G7.

During changing magnification from the wide angle end to the telephoto end, the second lens group G2, the third lens group G3, the fifth lens group G5, and the sixth lens group G6 move along the optical axis Z while changing spacings between adjacent lens groups, and the other lens groups are fixed relative to the image plane Sim. The focusing group consists of the sixth lens group G6. During focusing from the infinite distance object to the close distance object, the focusing group moves to the object side.

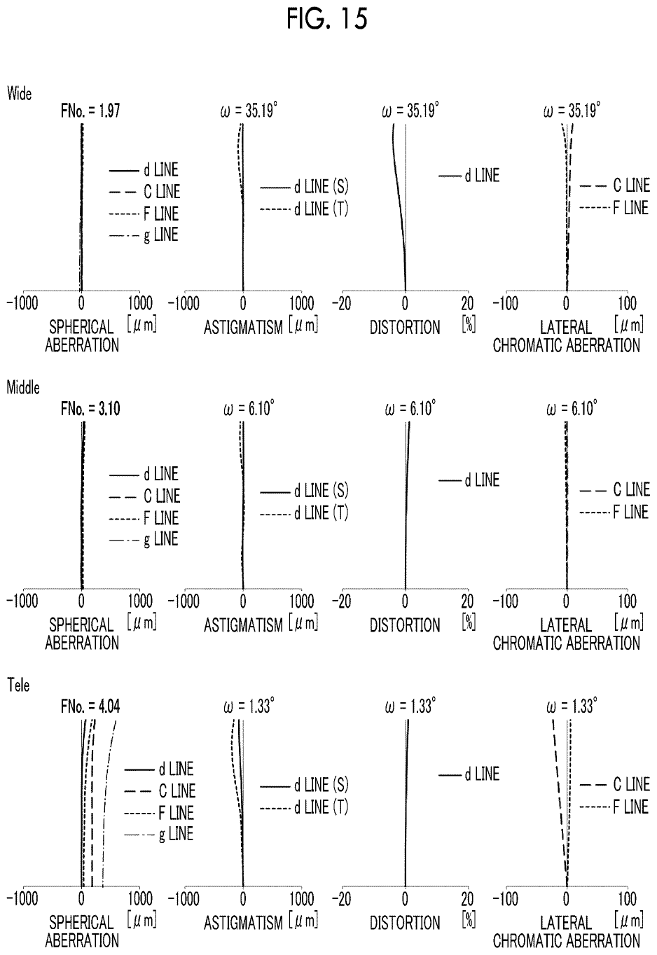

Regarding the zoom lens according to Example 7, Table 19 shows basic lens data, Table 20 shows specifications and variable surface spacings, Table 21 shows aspherical coefficients, and FIG. 15 shows each of the aberration diagrams.

TABLE 19
Example 7

| Sn | R | D | Nd | νd | θgF | Material | ED |
|---|---|---|---|---|---|---|---|
| 1 | 136.0630 | 1.9400 | 2.00069 | 25.47 | 0.61657 | H-ZLAF80.NHG | 65.49 |
| 2 | 83.1128 | 10.7085 | 1.43875 | 94.94 | 0.53433 | S-FPL53.OHARA | 63.96 |
| 3 | −1001.3358 | 0.1200 | | | | | 63.30 |
| 4 | 87.0798 | 5.4370 | 1.77535 | 50.31 | 0.55042 | H-LAK77.NHG | 61.55 |
| 5 | 215.5094 | DD[5] | | | | | 60.61 |
| 6 | 49.7804 | 5.2732 | 1.48071 | 85.29 | 0.53623 | FCD915.HOYA | 44.56 |
| 7 | 188.7007 | DD[7] | | | | | 43.81 |
| 8 | 125.8974 | 0.6752 | 2.05090 | 26.94 | 0.60519 | TAFD65.HOYA | 24.54 |
| 9 | 13.6655 | 5.9068 | | | | | 19.77 |
| 10 | −46.6704 | 5.2141 | 1.98613 | 16.48 | 0.66558 | FDS16-W.HOYA | 19.58 |
| 11 | −14.9060 | 1.0408 | 1.84850 | 43.79 | 0.56197 | J-LASFH22.HIKARI | 19.75 |
| 12 | 35.3555 | 0.8694 | | | | | 19.38 |
| 13 | 26.4819 | 6.7895 | 1.78880 | 28.42 | 0.60066 | J-KZFH10.HIKARI | 19.97 |
| 14 | −23.6438 | 0.7000 | 1.92286 | 20.89 | 0.63806 | H-ZF62.NHG | 19.84 |
| 15 | −1979.8348 | DD[15] | | | | | 19.90 |
| 16(St) | ∞ | 3.4723 | | | | | 24.39 |
| 17 | 102.3410 | 7.0424 | 1.84666 | 23.84 | 0.62012 | FDS90-SGP.HOYA | 25.35 |
| 18 | −21.7807 | 1.7600 | 1.78880 | 28.42 | 0.60066 | J-KZFH10.HIKARI | 25.37 |
| 19 | ∞ | DD[19] | | | | | 25.16 |
| 20 | ∞ | 8.1561 | 1.49700 | 81.61 | 0.53887 | FCD1.HOYA | 25.05 |
| 21 | −27.3647 | 0.7000 | 1.90200 | 25.26 | 0.61662 | J- | 24.84 |
| | | | | | | LASFH24HS.HIKARI | |
| 22 | −63.2650 | DD[22] | | | | | 25.27 |
| 23 | −2375.0957 | 8.0100 | 1.43875 | 94.66 | 0.53402 | S-FPL55.OHARA | 24.75 |
| 24 | −22.9575 | 1.0011 | 1.95375 | 32.32 | 0.59015 | TAFD45.HOYA | 24.69 |
| 25 | −40.9001 | 0.1601 | | | | | 25.50 |
| *26 | 53.2783 | 5.7632 | 1.58313 | 59.38 | 0.54237 | L-BAL42.OHARA | 25.50 |
| *27 | −35.3181 | DD[27] | | | | | 25.27 |
| 28 | −42.2214 | 2.5000 | 1.91082 | 35.25 | 0.58224 | TAFD35.HOYA | 23.34 |
| 29 | 36.0871 | 8.0100 | 1.59270 | 35.31 | 0.59336 | S-FTM16.OHARA | 23.46 |
| 30 | −27.4046 | 5.6180 | | | | | 24.00 |
| 31 | ∞ | 33.0000 | 1.60859 | 46.44 | 0.56664 | BAF52.SCHOTT | 21.46 |
| 32 | ∞ | 13.2000 | 1.51633 | 64.05 | 0.53463 | BK-7.SUMITA | 15.30 |
| 33 | ∞ | 5.5013 | | | | | 12.68 |

TABLE 20
Example 7

| | Object Distance | | | | | |
|---|---|---|---|---|---|---|
| | Infinite | Infinite | Infinite | 0.8 m | 0.8 m | 0.8 m |
| | Changing Magnification State | | | | | |
| | Wide | Middle | Tele | Wide | Middle | Tele |
| Zr | 1.00 | 6.28 | 29.00 | 1.00 | 6.28 | 29.00 |
| f | 8.10 | 50.85 | 234.98 | — | — | — |
| Bf | 40.34 | 40.34 | 40.34 | — | — | — |
| FNo. | 1.97 | 3.10 | 4.04 | 1.98 | 3.12 | 4.30 |
| 2ω[°] | 70.38 | 12.20 | 2.66 | 70.40 | 12.12 | 2.52 |
| DD[5] | 1.0297 | 21.8011 | 29.3781 | 1.0297 | 21.8011 | 29.3781 |
| DD[7] | 1.0102 | 32.8864 | 44.7445 | 1.0102 | 32.8864 | 44.7445 |
| DD[15] | 74.6975 | 22.0499 | 2.6147 | 74.6975 | 22.0499 | 2.6147 |
| DD[19] | 1.7339 | 3.9934 | 3.1989 | 1.7339 | 3.9934 | 3.1989 |
| DD[22] | 21.5720 | 10.5505 | 20.5183 | 21.5311 | 9.2334 | 2.8297 |
| DD[27] | 3.0601 | 11.8221 | 2.6488 | 3.1010 | 13.1392 | 20.3374 |

TABLE 21
Example 7

| Sn | 26 | 27 |
|---|---|---|
| KA | 2.9369555E+00 | 6.3728129E−01 |
| A3 | 0.0000000E+00 | 0.0000000E+00 |
| A4 | −2.3380545E−05 | −2.2671852E−05 |
| A5 | 1.1148516E−05 | 1.9796182E−05 |
| A6 | −2.9493140E−06 | −7.1032338E−06 |
| A7 | 4.8962713E−07 | 1.5970708E−06 |
| A8 | −6.1470719E−08 | −2.3218632E−07 |
| A9 | 4.7294721E−09 | 1.7484388E−08 |
| A10 | 1.3480418E−10 | 4.6646386E−10 |
| A11 | −6.3210567E−11 | −2.4034892E−10 |
| A12 | 2.3255739E−12 | 2.0311232E−11 |
| A13 | 5.2339408E−13 | −3.4329390E−13 |
| A14 | −6.4636945E−14 | −4.9457754E−14 |
| A15 | 2.8968063E−15 | 3.1803967E−15 |
| A16 | −4.7997664E−17 | −5.9272805E−17 |

### Example 8

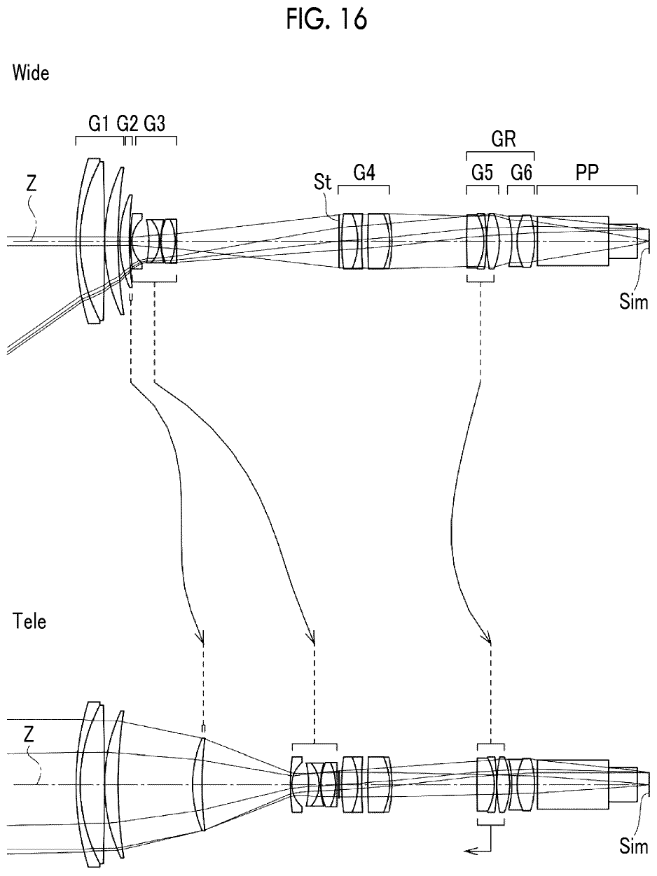

FIG. 16 shows a configuration and movement loci of a zoom lens according to Example 8. The zoom lens according to Example 8 consists of a first lens group G1 having a positive refractive power, a second lens group G2 having a positive refractive power, a third lens group G3 having a negative refractive power, a fourth lens group G4 having a positive refractive power, a fifth lens group G5 having a positive refractive power, and a sixth lens group G6 having a positive refractive power in order from the object side to the image side. The subsequent group GR consists of the fifth lens group G5 and the sixth lens group G6.

During changing magnification from the wide angle end to the telephoto end, the second lens group G2, the third lens group G3, and the fifth lens group G5 move along the optical axis Z while changing spacings between adjacent lens groups, and the other lens groups are fixed relative to the image plane Sim. The focusing group consists of the fifth lens group G5. During focusing from the infinite distance object to the close distance object, the focusing group moves to the object side.

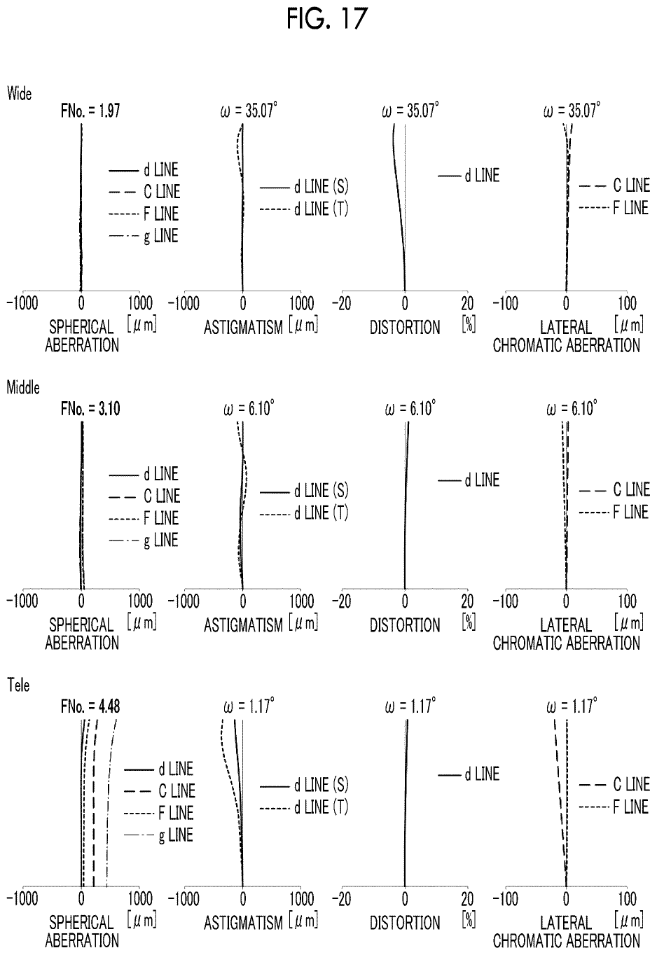

Regarding the zoom lens according to Example 8, Table 22 shows basic lens data, Table 23 shows specifications and variable surface spacings, Table 24 shows aspherical coefficients, and FIG. 17 shows each of the aberration diagrams.

TABLE 22
Example 8

| Sn | R | D | Nd | νd | θgF | Material | ED |
|---|---|---|---|---|---|---|---|
| 1 | 130.7011 | 1.9398 | 2.05090 | 26.94 | 0.60519 | TAFD65.HOYA | 65.20 |
| 2 | 77.8839 | 11.1802 | 1.43700 | 95.10 | 0.53364 | FCD100.HOYA | 63.52 |
| 3 | −1246.6205 | 0.1200 | | | | | 62.91 |
| 4 | 79.5979 | 6.2466 | 1.75500 | 52.32 | 0.54757 | S-LAH97.OHARA | 61.30 |
| 5 | 222.1922 | DD[5] | | | | | 60.24 |
| 6 | 53.0571 | 4.3719 | 1.57144 | 71.61 | 0.54193 | FCD615.HOYA | 42.60 |
| 7 | 171.6218 | DD[7] | | | | | 41.92 |
| 8 | 97.8358 | 0.6748 | 2.05090 | 26.94 | 0.60519 | TAFD65.HOYA | 25.50 |
| 9 | 13.4145 | 7.7511 | | | | | 20.28 |
| 10 | −46.1553 | 4.9023 | 1.98613 | 16.48 | 0.66558 | FDS16-W.HOYA | 19.74 |
| 11 | −15.0968 | 0.6848 | 1.84850 | 43.79 | 0.56197 | J-LASFH22.HIKARI | 19.93 |
| 12 | 36.1481 | 0.1198 | | | | | 19.83 |
| 13 | 25.3466 | 6.4997 | 1.78880 | 28.42 | 0.60066 | J-KZFH10.HIKARI | 20.32 |
| 14 | −22.5508 | 0.6998 | 1.92286 | 20.89 | 0.63806 | H-ZF62.NHG | 20.24 |
| 15 | −1416.9649 | DD[15] | | | | | 20.33 |
| 16(St) | ∞ | 1.1795 | | | | | 24.41 |
| 17 | 90.0948 | 7.5001 | 1.84666 | 23.84 | 0.62012 | FDS90-SGP.HOYA | 24.87 |
| 18 | −31.3870 | 1.7602 | 1.78880 | 28.42 | 0.60066 | J-KZFH10.HIKARI | 24.85 |
| 19 | 202.7048 | 2.8997 | | | | | 24.71 |
| 20 | 357.1543 | 10.0102 | 1.49700 | 81.61 | 0.53887 | FCD1.HOYA | 24.82 |
| 21 | −30.2803 | 1.1002 | 1.90200 | 25.26 | 0.61662 | J- | 24.86 |
| | | | | | | LASFH24HS.HIKARI | |
| 22 | −55.6837 | DD[22] | | | | | 25.30 |
| 23 | 314.2985 | 8.0095 | 1.43875 | 94.66 | 0.53402 | S-FPL55.OHARA | 24.47 |
| 24 | −26.4609 | 1.1002 | 1.90043 | 37.37 | 0.57668 | TAFD37A.HOYA | 24.33 |
| 25 | −93.7741 | 0.1198 | | | | | 25.05 |
| *26 | 54.1281 | 5.9913 | 1.58313 | 59.38 | 0.54237 | L-BAL42.OHARA | 25.47 |
| *27 | −32.2843 | DD[27] | | | | | 25.47 |
| 28 | −48.2365 | 2.4998 | 1.95203 | 26.20 | 0.61011 | NBFD265.HOYA | 22.95 |
| 29 | 27.9130 | 8.0102 | 1.85000 | 27.03 | 0.60935 | J-LASFH23.HIKARI | 23.32 |
| 30 | −39.5508 | 1.3382 | | | | | 23.73 |
| 31 | ∞ | 33.0000 | 1.60859 | 46.44 | 0.56664 | BAF52.SCHOTT | 22.66 |
| 32 | ∞ | 13.2000 | 1.51633 | 64.05 | 0.53463 | BK-7.SUMITA | 15.76 |
| 33 | ∞ | 5.5022 | | | | | 12.85 |

TABLE 23
Example 8

| | Object Distance | | | | | |
|---|---|---|---|---|---|---|
| | Infinite | Infinite | Infinite | 0.8 m | 0.8 m | 1.2 m |
| | Changing Magnification State | | | | | |
| | Wide | Middle | Tele | Wide | Middle | Tele |
| Zr | 1.00 | 6.28 | 33.00 | 1.00 | 6.28 | 33.00 |
| f | 8.11 | 50.89 | 267.59 | — | — | — |
| Bf | 36.06 | 36.06 | 36.06 | — | — | — |
| FNo. | 1.97 | 3.10 | 4.48 | 1.97 | 3.13 | 3.79 |
| 2ω[°] | 70.14 | 12.20 | 2.34 | 70.18 | 12.12 | 2.52 |
| DD[5] | 0.8149 | 24.3025 | 34.4719 | 0.8149 | 24.3025 | 34.4719 |
| DD[7] | 0.5885 | 30.2579 | 40.9146 | 0.5885 | 30.2579 | 40.9146 |
| DD[15] | 74.9400 | 21.7830 | 0.9569 | 74.9400 | 21.7830 | 0.9569 |
| DD[22] | 34.5718 | 21.1984 | 39.3473 | 34.5063 | 19.1030 | 14.6231 |
| DD[27] | 5.7134 | 19.0868 | 0.9379 | 5.7789 | 21.1822 | 25.6621 |

TABLE 24
Example 8

| Sn | 26 | 27 |
|---|---|---|
| KA | 1.8223098E+00 | 8.0258933E−01 |
| A3 | 0.0000000E+00 | 0.0000000E+00 |
| A4 | −3.8494459E−05 | −3.4038785E−05 |
| A5 | 1.0240789E−05 | 1.3612617E−05 |
| A6 | −5.7439748E−07 | −1.8799709E−06 |
| A7 | −2.3220612E−07 | 5.7372996E−08 |
| A8 | 6.2911634E−08 | 3.7109033E−08 |
| A9 | −8.3096973E−09 | −1.2459004E−08 |
| A10 | 4.8823064E−10 | 2.0814806E−09 |
| A11 | 2.5128187E−11 | −1.8882498E−10 |
| A12 | −5.1071400E−12 | 8.4081511E−12 |
| A13 | 7.8347025E−14 | −7.8570452E−14 |
| A14 | 2.4379929E−14 | −7.2468382E−15 |
| A15 | −1.5993780E−15 | 2.5783279E−16 |
| A16 | 3.0053058E−17 | −3.0608524E−18 |

Table 25 shows the corresponding values of Conditional Expressions (1) to (13) of the zoom lenses according to Examples 1 to 8. Preferable ranges of the conditional expressions may be set by using the corresponding values of the examples shown in Table 25 as the upper limits or the lower limits of the conditional expressions.

TABLE 25

| Expression | Conditional | | | | |
|---|---|---|---|---|---|
| Number | Expression | Example 1 | Example 2 | Example 3 | Example 4 |
| (1) | f1/ft | 0.675 | 0.826 | 0.658 | 0.640 |
| (2) | \|S2+S3\|/FNo | 0.488 | 0.333 | 0.534 | 0.555 |
| (3) | f1/f2 | 1.169 | 1.233 | 1.218 | 1.054 |
| (4) | N3min | 1.78880 | 1.78880 | 1.78880 | 1.83400 |
| (5) | θgFp | 0.63312 | 0.63312 | 0.63312 | 0.62158 |
| (6) | N1n | 2.00100 | 2.00069 | 2.05090 | 2.05090 |
| (7) | v2p | 90.27 | 76.45 | 71.62 | 82.57 |
| (8) | f1/f3 | −13.063 | −12.261 | −12.182 | −12.346 |
| (9) | D3/D2 | 2.7325 | 2.8667 | 2.2439 | 2.7471 |
| (10) | f4/fF | 2.617 | 2.074 | 1.930 | 2.847 |
| (11) | β3/β3w | 26.426 | 24.123 | 29.296 | 27.619 |
| (12) | SFw/FNow | 0.944 | 0.606 | 0.597 | 0.961 |
| (13) | dFf/TL | 0.1026 | 0.1220 | 0.1316 | 0.1018 |
| Expression | Conditional | | | | |
| Number | Expression | Example 5 | Example 6 | Example 7 | Example 8 |
| (1) | f1/ft | 0.683 | 0.685 | 0.662 | 0.556 |
| (2) | \|S2+S3\|/FNo | 0.487 | 0.477 | 0.515 | 0.691 |
| (3) | f1/f2 | 1.177 | 1.194 | 1.120 | 1.123 |
| (4) | N3min | 1.78880 | 1.78880 | 1.78880 | 1.78880 |
| (5) | θgFp | 0.63312 | 0.63312 | 0.63312 | 0.63312 |
| (6) | N1n | 2.00069 | 2.05091 | 2.00069 | 2.05090 |
| (7) | v2p | 85.30 | 82.57 | 85.30 | 71.62 |
| (8) | f1/f3 | −12.814 | −13.076 | −12.506 | −11.968 |
| (9) | D3/D2 | 2.6584 | 2.7022 | 2.5427 | 2.1981 |
| (10) | f4/fF | 2.512 | 2.760 | 2.586 | 1.982 |
| (11) | β3/β3w | 28.688 | 27.120 | 26.983 | 36.124 |
| (12) | SFw/FNow | 0.934 | 0.943 | 0.973 | 0.608 |
| (13) | dFf/TL | 0.0961 | 0.1026 | 0.0874 | 0.1586 |

In the zoom lenses according to Examples 1 to 8, while being configured to be small-sized, the zoom ratio is 20-fold or more, and an increase in magnification is achieved.

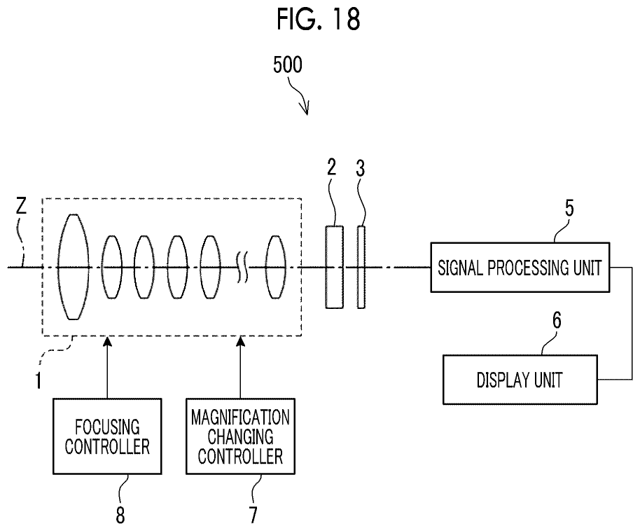

Next, an imaging apparatus according to an embodiment of the present disclosure will be described. FIG. 18 is a schematic configuration diagram showing an imaging apparatus 500 according to the embodiment of the present disclosure. The imaging apparatus 500 includes the zoom lens 1 according to the embodiment of the present disclosure, a filter 2 disposed on the image side of the zoom lens 1, and an imaging element 3 disposed on the image side of the filter 2. In FIG. 18, a plurality of lenses in the zoom lens 1 are schematically shown.

The imaging element 3 converts an optical image formed by the zoom lens 1 into an electric signal, and, for example, a charge coupled device (CCD), a complementary metal oxide semiconductor (CMOS), or the like can be used. The imaging element 3 is disposed such that an imaging surface thereof matches with the image plane of the zoom lens 1.

The imaging apparatus 500 further includes a signal processing unit 5, a display unit 6, a magnification changing controller 7, and a focusing controller 8. The signal processing unit 5 performs arithmetic processing on an output signal from the imaging element 3. The display unit 6 displays an image formed by the signal processing unit 5. The magnification changing controller 7 controls magnification changing of the zoom lens 1. The focusing controller 8 controls focusing of the zoom lens 1. Although FIG. 18 shows only one imaging element 3, a so-called three-plate imaging apparatus including three imaging elements may be used.

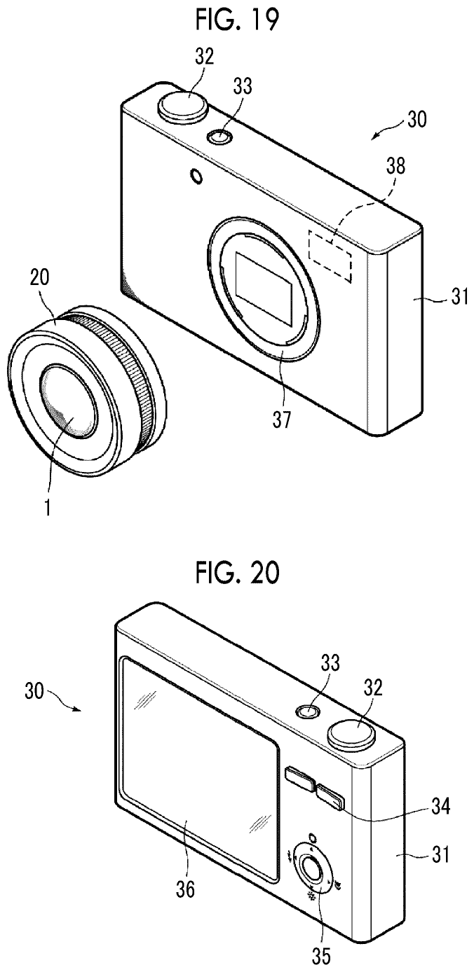

Next, an imaging apparatus according to an embodiment of the present disclosure will be described. FIGS. 19 and 20 are external views of a camera 30 that is the imaging apparatus according to the embodiment of the present disclosure. FIG. 19 is a perspective view showing the camera 30 when seen from the front side, and FIG. 20 is a perspective view showing the camera 30 when seen from the rear side. The camera 30 is a so-called mirrorless type digital camera in which an interchangeable lens 20 can be attachably and detachably mounted. The interchangeable lens 20 is configured to include the zoom lens 1 according to the embodiment of the present disclosure that is accommodated in a lens barrel.

The camera 30 includes a camera body 31. A shutter button 32 and a power button 33 are provided on an upper surface of the camera body 31. Further, an operator 34, an operator 35 and a display unit 36 are provided on the rear surface of the camera body 31. The display unit 36 can display a captured image and an image within an angle of view before imaging.

An imaging aperture through which light from an imaging target is incident is provided at the center on the front surface of the camera body 31. A mount 37 is provided at a position corresponding to the imaging aperture, and the interchangeable lens 20 is mounted in the camera body 31 via the mount 37.

An imaging element 38 is provided in the camera body 31. The imaging element 38 outputs an imaging signal corresponding to the subject image formed by the interchangeable lens 20. For example, a charge coupled device (CCD) or a complementary metal oxide semiconductor (CMOS) is used as the imaging element 38. A signal processing circuit (not shown), a recording medium (not shown), and the like are provided in the camera body 31. The signal processing circuit processes the imaging signal output from the imaging element 38 to generate an image. The recording medium is used to record the generated image. The camera 30 can capture a still image or a motion picture by pressing the shutter button 32, and records image data obtained through imaging in the recording medium.

The present disclosed technology has been hitherto described through the embodiments and the examples, but the present disclosed technology is not limited to the above-described embodiments and examples, and may be modified into various forms. For example, the curvature radius, the surface spacing, the refractive index, the Abbe number, the aspherical coefficient, and the like of each of the lenses are not limited to the values shown in the examples, and different values may be used therefor.

In addition, the imaging apparatus according to the embodiment of the present disclosure is not limited to the above-described examples, and can be used in various aspects, for example, a camera other than a mirrorless type, a camera where an imaging lens and a camera body are integrated, a film camera, a video camera, a surveillance camera, a broadcast camera, a movie camera, a camera for factory automation (FA), or a camera for machine vision (MV).

Regarding the above-described embodiments and examples, the following supplementary notes will be further disclosed.

### Supplementary Note 1

A zoom lens consisting of a first lens group having a positive refractive power, a second lens group having a positive refractive power, a third lens group having a negative refractive power, a fourth lens group, and a subsequent group consisting of two or more lens groups in order from an object side to an image side, in which all of spacings between adjacent lens groups change during changing magnification, the subsequent group includes a focusing group that moves along an optical axis during focusing, and in a case where a focal length of the first lens group is represented by f1, and a focal length of the zoom lens in a state where an infinite distance object at a telephoto end is in focus is represented by ft,
Conditional Expression (1) represented by

$$0.4 < f 1 / ft < 1 \qquad ( 1 )$$

is satisfied.

### Supplementary Note 2

The zoom lens according to Supplementary Note 1, in which in a case where an open F-number in a state where the infinite distance object at the telephoto end is in focus is represented by FNo, a lateral magnification of the second lens group in a state where the infinite distance object at the telephoto end is in focus is represented by β2, a combined lateral magnification of all lenses closer to the image side than the second lens group in a state where the infinite distance object at the telephoto end is in focus is represented by β2R, a lateral magnification of the third lens group in a state where the infinite distance object at the telephoto end is in focus is represented by β3, a combined lateral magnification of all lenses closer to the image side than the third lens group in a state where the infinite distance object at the telephoto end is in focus is represented by β3R, and

S2 and S3 represented by

$$S 2 = ( 1 - {β2}^{2} ) \times β2 {R}^{2} , and$$

$$S 3 = ( 1 - {β3}^{2} ) \times β3 {R}^{2}$$

are defined,
Conditional Expression (2) represented by

$$0.1 < \vert S 2 + S 3 \vert / FNo < 0.7 \qquad ( 2 )$$

is satisfied.

### Supplementary Note 3

The zoom lens according to Supplementary Note 1 or 2, in which in a case where a focal length of the second lens group is represented by f2, Conditional expression (3) represented by

$$1.02 < f 1 / f 2 < 2 \qquad ( 3 )$$

is satisfied.

### Supplementary Note 4

The zoom lens according to any one of Supplementary Notes 1 to 3, in which Conditional Expression (1-1) represented by

$$0.5 < f 1 / ft < 0.9 \qquad ( 1 - 1 )$$

is satisfied.

### Supplementary Note 5

The zoom lens according to Supplementary Note 2,
in which Conditional Expression (2-1) represented by

$$0.2 < \vert S 2 + S 3 \vert / FNo < 0.65 \qquad ( 2 - 1 )$$

is satisfied.

### Supplementary Note 6

The zoom lens according to any one of Supplementary Notes 1 to 5,
in which in a case where a minimum value of refractive indices of all lenses in the third lens group with respect to a d line is represented by N3 min,
Conditional Expression (4) represented by

$$1.65 < N 3 min < 1.95 \qquad ( 4 )$$

is satisfied.

### Supplementary Note 7

The zoom lens according to any one of Supplementary Notes 1 to 6,
in which in a case where an average value of partial dispersion ratios of all positive lenses in the third lens group between a g line and an F line is represented by θgFp,
Conditional Expression (5) represented by

$$0.615 < θ gFp < 0.66 \qquad ( 5 )$$

is satisfied.

### Supplementary Note 8

The zoom lens according to Supplementary Note 7,
in which Conditional Expression (5-1) represented by

$$0.62 < θ gFp < 0.65 \qquad ( 5 - 1 )$$

is satisfied.

### Supplementary Note 9

The zoom lens according to any one of Supplementary Notes 1 to 8, further comprising at least one negative lens that satisfies Conditional Expression (6),
in which in a case where a refractive index of a negative lens in the first lens group with respect to a d line is represented by N1n,
Conditional Expression (6) is represented by

$$1.85 < N 1 n < 2.15 . \qquad ( 6 )$$

### Supplementary Note 10

The zoom lens according to any one of Supplementary Notes 1 to 9, further comprising at least one positive lens that satisfies Conditional Expression (7),
in which in a case where an Abbe number of a positive lens in the second lens group with respect to a d line is represented by v2p,
Conditional Expression (7) is represented by

$$65 < v 2 p < 99. \qquad ( 7 )$$

### Supplementary Note 11

The zoom lens according to any one of Supplementary Notes 1 to 10,
in which in a case where a focal length of the third lens group is represented by f3,
Conditional expression (8) represented by

$$- 15 < f 1 / f 3 < - 10 \qquad ( 8 )$$

is satisfied.

### Supplementary Note 12

The zoom lens according to any one of Supplementary Notes 1 to 11,
in which in a case where
a difference in an optical axis direction between a position of the second lens group in a state where the infinite distance object at a wide angle end is in focus and a position of the second lens group in a state where the infinite distance object at the telephoto end is in focus is represented by D2, and
a difference in the optical axis direction between a position of the third lens group in a state where the infinite distance object at the wide angle end is in focus and a position of the third lens group in a state where the infinite distance object at the telephoto end is in focus is represented by D3,
Conditional Expression (9) represented by

$$2 < D 3 / D 2 < 3 \qquad ( 9 )$$

is satisfied.

### Supplementary Note 13

The zoom lens according to any one of Supplementary Notes 1 to 12,
in which the fourth lens group has a positive refractive power.

### Supplementary Note 14

The zoom lens according to any one of Supplementary Notes 1 to 13,
in which the focusing group has a positive refractive power.

### Supplementary Note 15

The zoom lens according to any one of Supplementary Notes 1 to 14,
in which in a case where
a focal length of the fourth lens group is represented by f4, and
a focal length of the focusing group is represented by fF,
Conditional Expression (10) represented by

$$1.8 < f 4 / fF < 3 \qquad ( 10 )$$

is satisfied.

### Supplementary Note 16

The zoom lens according to any one of Supplementary Notes 1 to 15,
in which the first lens group is fixed relative to an image plane during changing magnification.

### Supplementary Note 17

The zoom lens according to any one of Supplementary Notes 1 to 16,
in which the second lens group consists of one positive lens.

### Supplementary Note 18

The zoom lens according to any one of Supplementary Notes 1 to 17,
in which the focusing group includes at least one aspherical lens.

### Supplementary Note 19

The zoom lens according to any one of Supplementary Notes 1 to 18, in which the third lens group includes at least three negative lenses.

### Supplementary Note 20

An imaging apparatus comprising: the zoom lens according to any one of Supplementary Notes 1 to 19.

What is claimed is:

1. A zoom lens consisting of a first lens group having a positive refractive power, a second lens group having a positive refractive power, a third lens group having a negative refractive power, a fourth lens group, and a subsequent group consisting of two or more lens groups in order from an object side to an image side, wherein:
all of spacings between adjacent lens groups change during changing magnification,
the subsequent group includes a focusing group that moves along an optical axis during focusing, and
in a case where:
a focal length of the first lens group is represented by f1, and
a focal length of the zoom lens in a state where an infinite distance object at a telephoto end is in focus is represented by ft,
Conditional Expression (1) is satisfied:
$$0.4 < f 1 / ft < 1. \qquad ( 1 )$$

2. The zoom lens according to claim 1, wherein
in a case where:
an open F-number in a state where the infinite distance object at the telephoto end is in focus is represented by FNo,
a lateral magnification of the second lens group in a state where the infinite distance object at the telephoto end is in focus is represented by β2,
a combined lateral magnification of all lenses closer to the image side than the second lens group in a state where the infinite distance object at the telephoto end is in focus is represented by β2R,
a lateral magnification of the third lens group in a state where the infinite distance object at the telephoto end is in focus is represented by β3,
a combined lateral magnification of all lenses closer to the image side than the third lens group in a state where the infinite distance object at the telephoto end is in focus is represented by β3R, and
S2 and S3 are defined:
$$S 2 = ( 1 - {β2}^{2} ) \times β 2 {R}^{2} , and$$
$$S 3 = ( 1 - {β3}^{2} ) \times β 3 {R}^{2} ,$$
Conditional Expression (2) is satisfied:
$$0.1 < \vert S 2 + S 3 \vert / FNo < 0.7 . \qquad ( 2 )$$

3. The zoom lens according to claim 1, wherein
in a case where a focal length of the second lens group is represented by f2,
Conditional expression (3) is satisfied:
$$1.02 < f 1 / f 2 < 2. \qquad ( 3 )$$

4. The zoom lens according to claim 1, wherein Conditional Expression (1-1) is satisfied:
$$0.5 < f 1 / ft < 0.9 . \qquad ( 1 - 1 )$$

5. The zoom lens according to claim 2, wherein Conditional Expression (2-1) is satisfied:
$$0.2 < \vert S 2 + S 3 \vert / FNo < 0.65 . \qquad ( 2 - 1 )$$

6. The zoom lens according to claim 1, wherein
in a case where a minimum value of refractive indices of all lenses in the third lens group with respect to a d line is represented by N3min,
Conditional Expression (4) is satisfied:
$$1.65 < N 3 min < 1.95 . \qquad ( 4 )$$

7. The zoom lens according to claim 1, wherein
in a case where an average value of partial dispersion ratios of all positive lenses in the third lens group between a g line and an F line is represented by θgFp,
Conditional Expression (5) is satisfied:
$$0.615 < θ gFp < 0.66 . \qquad ( 5 )$$

8. The zoom lens according to claim 7, wherein Conditional Expression (5-1) is satisfied:
$$0.62 < θ gFp < 0.65 . \qquad ( 5 - 1 )$$

9. The zoom lens according to claim 1, further comprising at least one negative lens that satisfies Conditional Expression (6), wherein
in a case where a refractive index of a negative lens in the first lens group with respect to a d line is represented by N1n,
Conditional Expression (6) is represented by
$$1.85 < N 1 n < 2.15 . \qquad ( 6 )$$

10. The zoom lens according to claim 1, further comprising at least one positive lens that satisfies Conditional Expression (7), wherein
in a case where an Abbe number of a positive lens in the second lens group with respect to a d line is represented by v2p,
Conditional Expression (7) is represented by
$$65 < v 2 p < 99. \qquad ( 7 )$$

11. The zoom lens according to claim 1, wherein
in a case where a focal length of the third lens group is represented by f3,
Conditional expression (8) is satisfied:
$$- 15 < f 1 / f 3 < - 10. \qquad ( 8 )$$

12. The zoom lens according to claim 1, wherein
in a case where:
a difference in an optical axis direction between a position of the second lens group in a state where the infinite distance object at a wide angle end is in focus and a position of the second lens group in a state where the infinite distance object at the telephoto end is in focus is represented by D2, and
a difference in the optical axis direction between a position of the third lens group in a state where the infinite distance object at the wide angle end is in focus and a position of the third lens group in a state where the infinite distance object at the telephoto end is in focus is represented by D3,
Conditional Expression (9) is satisfied:
$$2 < D 3 / D 2 < 3. \qquad ( 9 )$$

13. The zoom lens according to claim 1, wherein the fourth lens group has a positive refractive power.

14. The zoom lens according to claim 1, wherein the focusing group has a positive refractive power.

15. The zoom lens according to claim 1, wherein
in a case where:
a focal length of the fourth lens group is represented by f4, and
a focal length of the focusing group is represented by fF,
Conditional Expression (10) is satisfied:
$$1.8 < f 4 / fF < 3. \qquad ( 10 )$$

16. The zoom lens according to claim 1, wherein the first lens group is fixed relative to an image plane during changing magnification.

17. The zoom lens according to claim 1, wherein the second lens group consists of one positive lens.

18. The zoom lens according to claim 1, wherein the focusing group includes at least one aspherical lens.

19. The zoom lens according to claim 1, wherein the third lens group includes at least three negative lenses.

20. An imaging apparatus comprising the zoom lens according to claim 1.
